(19) United States
(12) Patent Application Publication
(10) Pub. No.: US 2026/0127206 A1
(43) Pub. Date: May 7, 2026

(54) APPLICATION GENERATION SYSTEM BASED ON INGESTED DOCUMENTS USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Benji Bizzell, Asheville, NC (US); Neeraj Gupta, Austin, TX (US)

(73) Assignee: Trilogy Enterprises, Inc., Austin, TX (US)

(21) Appl. No.: 19/378,063

(22) Filed: Nov. 3, 2025

Related U.S. Application Data
(60) Provisional application No. 63/714,907, filed on Nov. 1, 2024.

(51) Int. Cl. G06F 16/334; G06F 11/3698; G06F 16/22; G06F 16/27; G06F 16/3329; G06F 40/30

(52) U.S. Cl. CPC G06F 16/3347; G06F 11/3698; G06F 16/2237; G06F 16/27; G06F 16/3329; G06F 40/30

(57) ABSTRACT

An application generation system and process using a user query and one or more documents ingested via an online document management platform is disclosed. The application generation process involves automatically ingesting documents from multiple sources, including local and cloud storage, using API bundles to create a vector database. The ingested documents are analyzed to identify patterns and contextual information, generating a priority score for the documents. Upon receiving a natural language input from the user, a prompt is generated based on the analyzed patterns to guide an AI engine. The AI engine utilizes the user query, prompts, and ingested documents to generate, test, and validate the application code in a simulated environment. The finalized application and its code are then presented to the user for execution.

### CROSS-REFERENCE TO RELATED APPLICATION(S)

This application claims the benefit under 35 U.S.C. § 119 (e) and 37 C.F.R. § 1.78 of U.S. Provisional Application No. 63/714,907, which is incorporated by reference in its entirety.

### FIELD OF THE INVENTION

The present invention generally relates to the field of electronics, and more specifically to an AI (Artificial Intelligence) driven system to generate an application based on ingested documents and queries provided by the user. The user can give any query to the generated application to perform the corresponding task.

### BACKGROUND OF THE INVENTION

Companies have faced numerous challenges in integrating Artificial Intelligence (AI) into their document management systems. Over the years, several approaches have been employed, each with its own set of limitations that hinder the seamless adoption of AI technologies. The three primary methods used have been direct integration of AI models, custom-built interfaces, and third-party solutions. However, all these approaches have struggled to meet the dynamic needs of businesses, especially as AI technology evolves rapidly.

The first approach, direct integration of AI Models, involves integrating AI directly into the company's systems. This approach requires users to interact with AI models through programming interfaces, such as APIs, or specialized tools designed to connect the AI models to the existing document management systems. While this method offers the most direct control over AI capabilities, it demands a deep understanding of the AI models, their parameters, and the specific data they require. Users need to have a high level of technical expertise to manage these integrations effectively, making it a less viable option for organizations without specialized AI knowledge. Configuring and managing these models can be complex and time-consuming, requiring ongoing attention to ensure they are working as expected.

The second approach is the use of custom-built interfaces in correspondence to specific AI functionalities. These interfaces are designed to meet the unique needs of an organization by allowing users to interact with AI models through a user-friendly platform. While custom-built interfaces offer some level of abstraction from the complex technicalities of AI models, they are often rigid and not easily adaptable to new or evolving AI technologies. Such systems still require a certain level of technical knowledge to operate effectively, particularly when it comes to adjusting the AI models as business requirements change. Moreover, because these interfaces are designed with a specific functionality in mind, they are often limited in their ability to adapt to new tasks or incorporate additional AI capabilities.

The third approach involves third-party solutions, where companies rely on external platforms to integrate AI into their document management systems. These platforms offer a level of abstraction that simplifies the use of AI, reducing the need for deep technical knowledge. However, this convenience often comes at the cost of flexibility and customization. Third-party solutions tend to operate within the confines of the vendor's vision and update cycle, meaning that companies have limited control over the AI's behavior and development. This reliance can create a significant dependency on the vendor, which becomes problematic if the vendor's updates do not align with the company's evolving needs. Moreover, the third-party platforms are usually designed to cater to a broad audience and may not offer the specific functionalities or customizations needed for a particular business. As a result, companies are forced to adjust their workflows to fit the capabilities of the software, rather than having a solution tailored to their unique operational requirements.

Overall, all these approaches share several drawbacks that make them less than ideal for companies looking to leverage AI in their document management systems. One of the most significant challenges is the requirement for deep technical knowledge. Whether it's directly integrating AI models, building custom interfaces, or managing third-party solutions, all these methods demand a certain level of expertise that many organizations may not have readily available. Additionally, integration often requires extensive customization, which increases both time and cost. For many companies, the resources needed to implement and maintain these integrations can outweigh the benefits, leading to high development and maintenance costs that are unsustainable in the long term. Less flexibility in adapting to new AI technologies or adjusting to changing business requirements further compounds these issues, as the rigid nature of existing solutions makes it difficult for organizations to remain agile and responsive in a fast-evolving technological landscape.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary application generation system that utilizes documents ingested by the user in an online document management platform.

FIG. 2 depicts an exemplary application generation process that utilizes documents ingested by the user in an online document management platform.

FIG. 3 depicts an exemplary ingested documents processing system, which is an embodiment of the document ingestion system that manages documents and generates an application using a user query of FIG. 1.

FIG. 4 depicts an exemplary user interface where the user can either directly enter the query or ingest documents along with the query to get the result as per user requirements.

FIG. 5 depicts an exemplary user interface that allows the user to change the settings of the online document management platform.

FIGS. 6 and 7 depict exemplary user interfaces displaying multiple API bundles using which the documents are ingested to the ingested document processing module to process the user's query.

FIG. 8 depicts an exemplary user interface that allows users to enter the query, for which the user needs a solution.

FIG. 9 depicts an exemplary vector database that provides the details of the metadata divided into chunks.

FIG. 10 depicts an application streaming process, which is an embodiment of the application generation process that utilizes documents ingested by the user in an online document management platform of FIG. 2.

FIGS. 11-13 depict various applications generated by the application generation system that utilizes documents ingested by the user in an online document management platform, based on the user queries.

FIG. 14 depicts an exemplary knowledge graph generation based on the input queries provided by the user.

FIG. 15 depicts a user interface in which the user provides a query on the online document management platform to generate a calculator application.

FIG. 16 depicts a user interface showing the AI-generated application code to generate the application.

FIG. 17 depicts a user interface showing the generated calculator application.

FIG. 18 depicts an exemplary network environment in which the application generation system that utilizes documents ingested by the user in an online document management platform of FIG. 1 and the application generation process that utilizes documents ingested by the user in an online document management platform of FIG. 2 may be practiced.

FIG. 19 depicts an exemplary computer system.

### DETAILED DESCRIPTION

An application generation system and process using a user query and one or more documents ingested via an online document management platform is disclosed. The online document management platform is operatively coupled to an ingested document processing module. A data ingestor, integrated within the ingested document processing module receives the documents ingested by the user, either through local storage or cloud storage, via multiple API bundles to generate a vector database. The data ingestor transfers the created vector database for further analysis using an analyzer which provides a priority score to the documents based on the order of their relevance, freshness, and so on.

The prioritized documents along with a prompt structure generated by a prompt engineer are provided to a prompt generator, which populates the prompt structure, thereby generating prompts which are used by an AI (Artificial Intelligence) engine. The AI engine uses the available prompts to generate an application code using a code generator and tests the generated application codes using a code tester. Finally the generated application along with the application codes and code description are displayed to the user on the online document management platform. The user can access the generated application and make changes, if necessary, by again writing the changes needed in the form of a query on a chatbot integrated within the online document management platform.

The application generation system offers several advantages by the integration of user queries and ingested documents. The application generation system automates the ingestion of documents from multiple sources, including local and cloud storage, creating a vector database that enhances the contextual understanding needed for application development. By analyzing this database for patterns and contextual information, the relevant documents are prioritized and provided a priority score, ensuring that the most pertinent data influences the application's design. This reduces the manual effort required in coding by utilizing AI-guided prompts structured with rules, guidelines, and examples, which lead to more accurate and contextually relevant application code. The automated testing environment further ensures that the generated code is reliable and performs well under simulated real-world conditions, allowing for rapid identification and resolution of errors.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

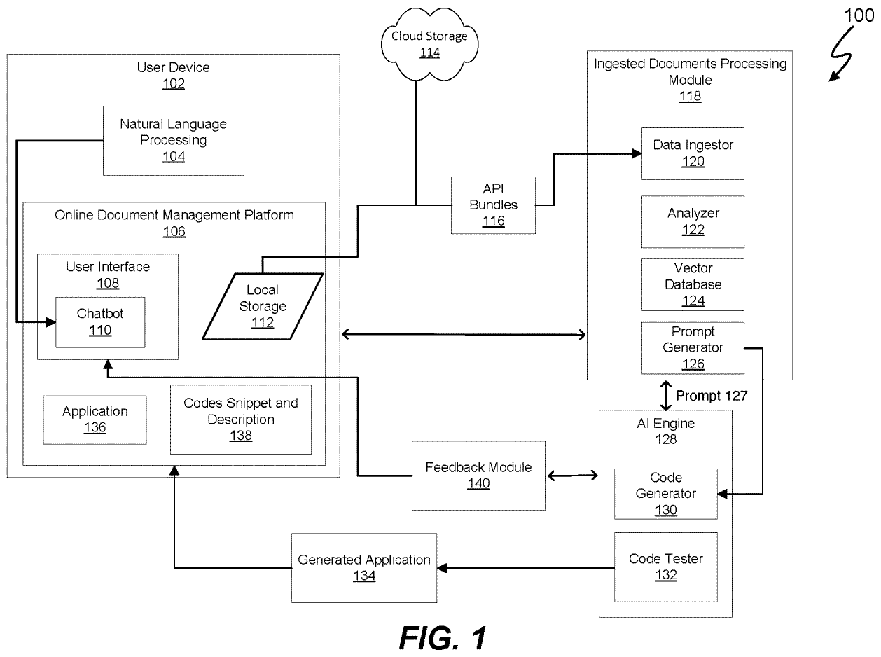

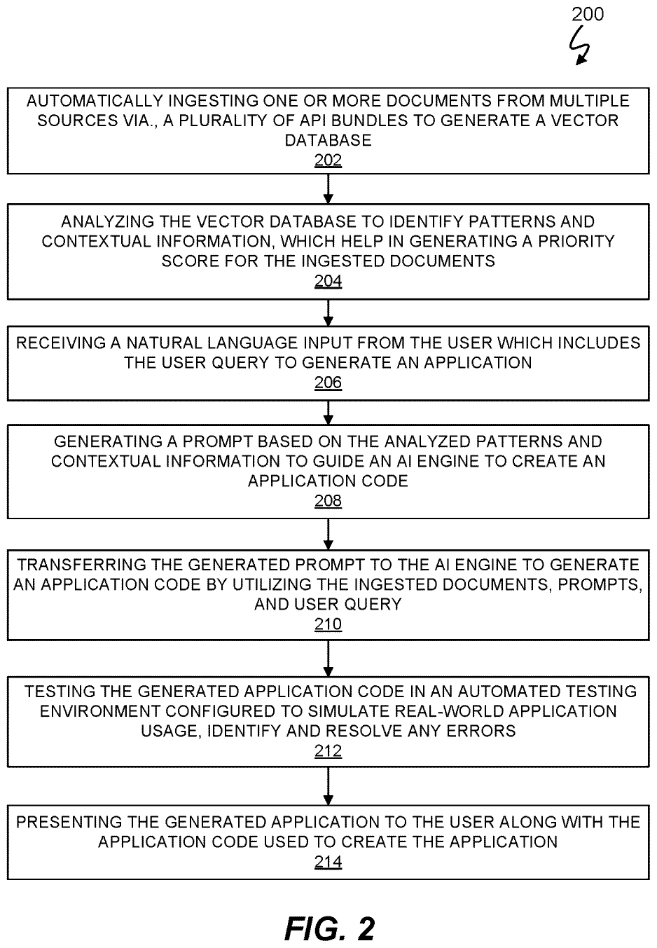

FIG. 1 depicts an exemplary application generation system 100 that utilizes documents ingested by the user in an online document management platform 106. FIG. 2 depicts an exemplary application generation process 200 that utilizes documents ingested by the user in an online document management platform 106, utilized by the application generation system 100.

Referring to FIGS. 1 and 2, in operation 202, a data ingestor 120 automatically ingests one or more documents from multiple sources via a plurality of API bundles 116 to generate a vector database 124. The multiple sources from where the documents are ingested include local storage 112 or cloud storage 114.

The data ingestor 120 is designed to automatically ingest one or more documents from various sources via a plurality of API bundles 116 to generate a vector database 124. These sources include local storage 112 and cloud storage 114, providing a flexible means for document ingestion. The ingestor 120 operates within an ingested document processing module 118, which is integrated with and operatively coupled to the online document management platform 106, enabling seamless data flow and processing.

The ingested documents come in multiple formats, such as PDFs, text files, spreadsheets, emails, messages, and JSON files, making the system versatile and capable of handling a wide range of content types. Users can provide a link to a folder, specifying its location within the online document management platform 106, whether the folder resides in local storage 112 or cloud storage 114. Once the link is provided, the data ingestor 120 uses API bundles 116 to facilitate secure communication between the local storage 112 or cloud storage 114 and the data ingestor 120. These API bundles 116 act as connectors, allowing the data ingestor 120 to access files from both local sources 112 and cloud sources 114. For instance, local storage 112 may use APIs to access file directories, while cloud storage 114 APIs connect to services like AWS S3, Google Drive, or Microsoft OneDrive.

Through these API bundles 116, the data ingestor 120 can pull documents directly from the linked folder provided by the user, regardless of the storage location or document format. Once ingested, the documents are passed to the ingested document processing module 118 for further actions such as indexing, categorization, or content extraction.

The API bundles 116 include multiple APIs that are structured to efficiently collect data from both local storage 112 and cloud storage 114, supporting real-time document ingestion. This structure ensures that documents are up-to-date and readily available for further processing. The API bundles 116 are configured to handle document ingestion in various formats.

Once the documents are ingested, the ingested documents processing module 118 utilizes machine learning algorithms to convert the textual content of the analyzed documents into vector embeddings, which are represented in a numerical format. These embeddings capture the relationships between words, entities, and document sections, allowing for efficient retrieval of relevant information. The ingested documents processing module 118 further processes the embedded vector data by chunking it into smaller, coherent segments based on semantic analysis, such as sections, paragraphs, or topics. This chunking enables more granular processing and retrieval, enhancing the ability of the ingested documents processing module 118 to manage, search, and analyze the ingested documents effectively.

The embedding, chunking, and conversion of the embedded documents into the vector database 124, along with the corresponding prompts are explained in U.S. Provisional Patent Application No. 63/714,909, which is hereby incorporated by reference in its entirety.

In operation 204, an analyzer 122 analyzes the vector database 124 to identify patterns and contextual information. The patterns and contextual information help in generating a priority score for the ingested documents.

The analyzer 122 plays a critical role in examining the vector database 124 to identify patterns and contextual information that help prioritize the ingested documents. The analyzer 122 is integrated within the ingested documents processing module 118 and is configured to receive documents directly from the data ingestor 120. The analyzer 122 uses Natural Language Processing (NLP) techniques to identify and extract key terms, and entities, such as names, places, dates, and the relationships within the documents, which provide a deeper understanding of the document content and context.

The analyzer 122 performs semantic analysis to extract the meaning and context of the ingested documents. This analysis allows the analyzer 122 to tag each document with metadata based on the identified content, context, and semantic insights, thereby providing a structured understanding of the documents. The extracted patterns and contextual information are then used to generate a priority score for each document, which is essential for ranking the documents based on factors such as source reliability, content importance, or freshness of the information.

During prioritization, each document is assigned a priority score, with those scoring below 3 being ignored or excluded from application generation. This ensures that only the most relevant and reliable information is considered. The priority scores are crucial during information retrieval, as they rank documents to ensure that higher-priority content is retrieved first, enhancing the relevance and quality of search results.

The analysis process also involves refining the document list by removing documents with high-priority scores and re-ranking the remaining documents using Large Language Model (LLM) tools. Once re-ranked, these documents are combined with those holding high priority scores, ensuring that the most valuable information is integrated and readily accessible for subsequent application generation. This iterative approach allows the analyzer 122 to dynamically manage the document pool, continually enhancing the relevance and precision of the content available for user queries.

In operation 206, a chatbot 110 integrated within a user interface 108 of a user device 102 receives a natural language input from the user. The natural language processing 104 is done to understand the user input and generate an application.

The chatbot 110, integrated within a user interface 108, serves as an interactive component of the online document management platform 106. The chatbot 110 receives natural language inputs from users, which include user queries for generating applications based on the uploaded and processed documents. In another embodiment, the user may directly provide a query to the online document management platform 106, without ingesting the documents. In return, the application generation system 100 will generate an application based on the user query only.

The chatbot 110 is designed to understand user queries in a conversational format, enabling users to communicate their needs without needing to use technical or structured commands. The natural language input is a prompt that includes detailed context, rules, and guidelines that specify how the application should be designed.

Since the chatbot 110 is integrated within the online document management platform 106, chatbot 110 provides seamless integration with other components, allowing it to access relevant data, documents, and analytical insights generated by the online document management platform 106. When a user submits a query, the chatbot 110 interprets the natural language input and forwards it to the ingested document processing module 118, where it triggers the relevant processes for application generation. This integration simplifies the user experience, enabling users to interact with the online document management platform 106 and receive precise outputs aligned with their requests.

In operation 208, a prompt generator 126 generates a prompt 127 based on the analyzed patterns and contextual information to guide an AI engine 128 to create an application code. The prompt 127 is generated by populating a prompt structure that includes a prompt template along with rules, guidelines, and examples to generate the application.

Before the generation of the prompt 127, a prompt engineer provides the prompt structure to the prompt generator 126. The prompt structure includes a set of rules and guidelines, examples, and a template for writing a prompt as well as generating a response. The prompt generator 126 utilizes the prioritized ingested documents and user query to populate the prompt structure.

An exemplary prompt structure generated by the prompt engineer which is utilized to generate prompts by the prompt generator 126 is given below:

```
dynamic_task_prompt system = ″″″
You are Anne Bonny, an AI assistant specialized at creating structured task
plans out of user requests, using a defined set of subtask types to choose
from. Your output should be a JSON array of subtasks, each with a specific
type, ID, query, and (where applicable) dependencies.
Available subtask types:
RETRIEVE: Used to gather additional context from a Private Vector Store.
GENERATE_TEXT: Used to generate a text-based response.
GENERATE_CODE: Used to generate a React App.
AGGREGATE: Used to combine text outputs from two different steps for use in a
later step.
Subtask Rules:
- AGGREGATE tasks must have dependencies on the tasks that are used to create
the aggregate, which are usually two RETRIEVE tasks.
- GENERATE_CODE tasks must have a dependency on the GENERATE_TEXT task that
is used to create the code.
Instructions:
1. Analyze the user's request and break it down into necessary subtasks.
2. For each subtask, determine the appropriate type from the available
options.
3. Assign a unique ID to each subtask, following the format:
<type_lowercase>_<number> (e.g., retrieve_1, generate_text_2).
4. Provide a relevant query for each subtask, except for AGGREGATE tasks
where the query can be empty.
5. Determine dependencies between tasks and list them where applicable.
6. Output the result as a JSON array of objects, each representing a subtask.
Output Format:
[
  {
    “type”: “TASK_TYPE”,
    “id”: “task_id”,
    “query”: “task_query”,
    “dependencies”: [“dependent_task_id_1”, “dependent_task_id_2”]
  },
  ...
]
Note: The “dependencies” field should only be included if the task has
dependencies.
Example:
User Request: “Compare the characteristics of cyborgs and centaurs.”
Output:
jsonCopy[
  {“type”: “RETRIEVE”, “id”: “retrieve_1”, “query”: “What is a Cyborg?”},
  {“type”: “RETRIEVE”, “id”: “retrieve_2”, “query”: “What is a Centaur?”},
  {“type”: “AGGREGATE”, “id”: “aggregate_1”, “dependencies”: [“retrieve_1”,
“retrieve_2”]},
  {“type”: “GENERATE_TEXT”, “id”: “generate_text_1”, “query”: “Compare the
characteristics of cyborgs and centaurs”, “dependencies”: [“aggregate_1”]}
]
Now, please process the following user request and generate an appropriate
task plan:
[USER_REQUEST]
```

In operation 210, the prompt generator 126 transfers the generated prompt 127 to the AI engine 128 to generate an application code by using a code generator 130 that utilizes the ingested documents, prompts, and user query.

The prompt generator 126 plays a pivotal role in transforming user inputs and contextual data into structured prompts that guide the AI engine 128 in generating application code. Once the prompt 127 is formulated, it is transferred to the AI engine 128, which is equipped with a code generator 130. This code generator 130 utilizes the ingested documents, user query, and generated prompt 127 to create application code in correspondence to the user's requirements. The AI engine 128 is specifically trained to handle a variety of programming languages and frameworks, including Python, Java, JavaScript, React, Streamlit, and others, based on the user's requirements. This specialized training allows the code generator 130 to produce accurate and functional code that aligns with the programming language and framework preferences specified in the user's query.

While code generator 130 typically uses the ingested documents to enrich the generated application code with relevant data and context, it is also capable of generating code based on the user query and generated prompts without relying on ingested documents. By efficiently utilizing the generated prompts and adapting to user queries, the code generator 130 ensures that the produced application code is not only syntactically correct but also aligned with the intended functionality, making the process of application development more streamlined and responsive to user inputs.

React code refers to code written using React, a popular JavaScript library developed by Facebook for building user interfaces, particularly for single-page applications. React allows developers to create reusable UI components that manage their state, leading to dynamic and interactive web pages. React is widely used for its efficiency, flexibility, and ability to create rich, responsive user experiences.

Exemplary guidelines and rules to generate the React code in the application generation system 100 are given below:

You are an AI assistant specialized in generating React components based on
user project ideas. Your task is to provide functional TypeScript React code
that fulfills the user's request. You will create a Next.js 13+ app that
reloads automatically. Using the app router. Always add the “‘use client’”
expression on the first line of the file.
Current date and time: {date_today}
React Component Guidelines:
1. Use TypeScript for all code.
2. Ensure the component is interactive and functional by creating state when
needed.
3. Use a default export for the main component.
4. Do not use any required props. Provide default values for all props if
used.
5. Use Tailwind classes for styling. Do not use arbitrary values (e.g., ‘h-
[600px]‘).
6. Maintain a consistent color palette.
7. Do not import or use any external libraries except those explicitly
mentioned in the Available Imports section.
8. The component must be entirely self-contained and able to run via a single
App.tsx file.
9. Do not reference or rely on any external components or files not provided
within the generated code.
10. Include all necessary types, interfaces, and utility functions.
11. Unless a full-screen app is required to fulfill the user's request, place
all content within a single container component that is centered on the page
horizontally and vertically.
12. Unless a particular design is explicitly requested, aim for a simple,
clean, and modern design. Select a color palette that is easy on the eyes and
visually appealing.
13. Consider user experience and accessibility when designing the component;
ensure that the component is easy to use and understand.
Available Imports:
- React (including hooks): ‘import React, {{ useState, useEffect, ... }} from
‘react’ ‘
- Base React is available. To use hooks, first import them at the top of the
code.
NO OTHER LIBRARIES (e.g. zod, hookform) ARE INSTALLED OR ABLE TO BE IMPORTED.
IMPORTANT!!! Your response should consist solely of the generated code, with
no additional text before or after (e.g. no comments, no markdown formatting,
or ‘‘‘ delimiters etc.)

Streamlit code, on the other hand, is used in Streamlit, an open-source Python library designed for building data-driven web applications quickly and easily. Streamlit allows developers to create interactive dashboards and applications with minimal coding, primarily focusing on data visualization, machine learning models, and custom data analysis tools. Streamlit is favored for its simplicity and rapid development cycle, making it popular among data scientists and engineers who need to turn their Python scripts into shareable web apps.

An exemplary prompt 127 generated by the prompt generator 126 by populating the above-mentioned prompt structure, to guide and constrain the AI engine 128 is given below:

```
dynamic_task_prompt_system = ″″″
You are Anne Bonny, an AI assistant specialized at creating structured task
plans out of user requests, using a defined set of subtask types to choose
from. Your output should be a JSON array of subtasks, each with a specific
type, ID, query, and (where applicable) dependencies.
Available subtask types:
RETRIEVE: Used to gather additional context from a Private Vector Store.
GENERATE_TEXT: Used to generate a text-based response.
GENERATE_CODE: Used to generate a React App.
AGGREGATE: Used to combine text outputs from two different steps for use in a
later step.
Subtask Rules:
- AGGREGATE tasks must have dependencies on the tasks that are used to create
the aggregate, which are usually two RETRIEVE tasks.
- GENERATE_CODE tasks must have a dependency on the GENERATE_TEXT task that
is used to create the code.
Instructions:
1. Analyze the user's request and break it down into necessary subtasks.
2. For each subtask, determine the appropriate type from the available
options.
3. Assign a unique ID to each subtask, following the format:
<type_lowercase>_<number> (e.g., retrieve_1, generate_text_2).
4. Provide a relevant query for each subtask, except for AGGREGATE tasks
where the query can be empty.
5. Determine dependencies between tasks and list them where applicable.
6. Output the result as a JSON array of objects, each representing a subtask.
Output Format:
[
  {
    “type”: “TASK_TYPE”,
    “id”: “task_id”,
    “query”: “task_query”,
    “dependencies”: [“dependent_task_id_1”, “dependent_task_id_2”]
  },
  ...
]
Note: The “dependencies” field should only be included if the task has
dependencies.
Example:
User Request: “Compare the characteristics of cyborgs and centaurs.”
Output:
jsonCopy[
  {“type”: “RETRIEVE”, “id”: “retrieve_1”, “query”: “What is a Cyborg?”},
  {“type”: “RETRIEVE”, “id”: “retrieve_2”, “query”: “What is a Centaur?”},
  {“type”: “AGGREGATE”, “id”: “aggregate_1”, “dependencies”: [“retrieve_1”,
“retrieve_2”]},
  {“type”: “GENERATE_TEXT”, “id”: “generate_text_1”, “query”: “Compare the
characteristics of cyborgs and centaurs”, “dependencies”: [“aggregate_1”]}
]
Now, please process the following user request and generate an appropriate
task plan:
[{
  “namespace”: “drive_1ya3gwhzbo-eiit6sykkxulmaey-ufkid”,
  “query”: “What is required for R&D expenses to qualify for the Section 41 tax credit?”,
  “top_k”: 5
}
]
```

An exemplary code to generate the application based on the user query and ingested documents is given below:

```
import logging
import asyncio
from typing import List, Dict, Any, Callable
from pydantic import BaseModel
from enum import Enum
from app.models.pydantic_models import InteractRequest, ProcessedQuery,
SubTask, TaskType
logger = logging.getLogger(“antenna.services.query_preprocessor”)
class QueryPreprocessorService:
  def _{——}init_{——}(self, classify_request: Callable[[str, str], str],
confirm_company_name: Callable[[str, str], str]):
    self.classify_request = classify_request
    self.confirm_company_name = confirm_company_name
  async def preprocess_query(self, request: InteractRequest) −>
ProcessedQuery:
    high_level_action = await self.classify_request(request.query,
request.lm_type)
    high_level_action = high_level_action.strip( ).lower( ).strip(‘ ‘’ ’)
    logger.info(f“Normalized high level action: {high_level_action}”)
    if high_level_action == “acquisition”:
      logger.info(“Generating acquisition tasks”)
      company_name = await self.confirm_company_name(request.query,
request.lm_type)
      sub_tasks =
self._generate_product_acquisition_summary(company_name)
    elif high_level_action in [“new_app”, “edit_app”]:
      logger.info(“Generating React tasks”)
      sub_tasks = self._generate_react_tasks(request.query)
    else:
      logger.info(“Generating simple QnA tasks”)
      sub_tasks = self._generate_simple_qna_tasks(request.query)
    # else:
    # # Default to dynamic sub-tasks generation for unknown actions
    # sub_tasks = await self._generate_dynamic_sub_tasks(request)
    return ProcessedQuery(high_level_action=high_level_action,
sub_tasks=sub_tasks)
  async def _classify_request(self, request: InteractRequest) −> str:
    return await self.interact_service._classify_request(request.query,
request.lm_type)
  async def _confirm_company_name(self, request: InteractRequest) −> str:
    return await
self.interact_service._confirm_company_name(request.query, request.lm_type)
  def _generate_react_tasks(self, query: str) −> List[SubTask]:
    return [
      SubTask(
        id=“generate_code”,
        task_type=TaskType.GENERATE_CODE,
        description=“Generating React code”,
        parameters={“query”: query}
      )
    ]
  def _generate_streamlit_tasks(self, query: str) −> List [SubTask]:
    return [
      SubTask(
        id=“generate_code”,
        task_type=TaskType.GENERATE_CODE,
        description=“Generating Streamlit code”,
        parameters={“query”: query}
      )
    ]
  def _generate_simple_qna_tasks(self, query: str) −> List [SubTask]:
    return [
      SubTask(
        id=“retrieve_info”,
        task_type=TaskType.RETRIEVE,
        description=“Retrieving relevant information”,
        parameters={“query”: query}
      ),
      SubTask(
        id=“generate_answer”,
        task_type=TaskType.GENERATE_TEXT,
        description=“Generating answer”,
        parameters={“query”: query},
        dependencies=[“retrieve_info”]
      )
    ]
    def _generate_product_acquisition_summary(self, company_name: str) −>
List[SubTask]:
    return [
      SubTask(
        id=“acquisition”,
        task_type=TaskType.ACQUISITION,
        description=“Generating Acquisition Summary”,
        parameters={“company_name”: company_name},
      )
    ]
  async def _generate_dynamic_sub_tasks(self, request: InteractRequest) −>
List[SubTask]:
    # This method would use an LLM to dynamically generate the task queue
    # For demonstration, we'll use a mock implementation
    task_queue = self._mock_llm_task_generation(request.query)
    return self._convert_task_queue_to_sub_tasks(task_queue)
  def _mock_llm_task_generation(self, query: str) −> List [Dict[str, Any]]:
    # This is a mock implementation. In reality, this would be an LLM
call.
    return [
      {“type”: “RETRIEVE”, “id”: “retrieve_1”, “query”: “What is a
Cyborg?”} ,
      {“type”: “RETRIEVE”, “id”: “retrieve_2”, “query”: “What is a
Centaur?”} ,
      {“type”: “AGGREGATE”, “id”: “aggregate_1”, “query”: “”
“dependencies”: [“retrieve_1”, “retrieve_2”]},
      {“type”: “GENERATE_TEXT”, “id”: “generate_text_1”, “query”: “What
are the similarities and differences between a Cyborg and a Centaur?”,
“dependencies”: [“aggregate_1”]},
    ]
  def _convert_task_queue_to_sub_tasks(self, task_queue: List [Dict[str,
Any]]) −> List[SubTask]:
    sub_tasks = [ ]
    for task in task_queue:
      task_type = TaskType[task[“type”]]
      sub_tasks.append(SubTask(
        id=task[“id”],
        task_type=task_type,
        description=f“Perform {task_type.value} operation”,
        parameters={“query”: task[“query”]},
        dependencies=task.get(“dependencies”, [ ])
      ))
    return sub_tasks
if _{——}name_{——} == “_{——}main_{——}”:
  output =
asyncio.run(QueryPreprocessorService._generate_dynamic_sub_tasks(InteractRequ
est(query=“Tell me of the republic of pirates”, lm_type=“sambanova”)))
  print(output)
```

The provided code defines a QueryPreprocessorService class, designed to preprocess user queries and generate corresponding tasks based on the identified high-level actions. It utilizes asynchronous programming with asyncio and leverages Pydantic for data validation through models like InteractRequest, ProcessedQuery, and SubTask. The class includes methods to classify requests, confirm company names, and generate tasks for different scenarios such as acquisitions, app development, or simple question-and-answer tasks. The tasks are structured as SubTask instances with defined types and parameters. Additionally, a mock implementation simulates dynamic task generation based on queries, illustrating how the service could be extended to use language models for task creation. The main block demonstrates calling the generate_dynamic_sub_tasks method with a sample query, though it seems to incorrectly attempt to call a class method directly on an instance method, which would raise an error.

An exemplary code for analyzing user query and generating the response is given below:

In operation 212, a code tester 132 tests the generated application code in an automated testing environment configured to simulate real-world application usage, and identify and resolve any errors.

The code tester 132 is an essential component of the application generation process 200, responsible for ensuring the quality and functionality of the generated application code. The code tester 132 operates within an automated testing environment specifically configured to simulate real-world usage scenarios of the application. This environment replicates the conditions under which the application would typically run, allowing the code tester 132 to evaluate the generated application code for errors, bugs, or performance issues that could affect its reliability and user experience. During the testing phase, code tester 132 systematically executes various test cases, including unit tests, integration tests, and performance tests, to identify flaws and inconsistencies in the code.

Upon detecting errors, code tester 132 generates detailed error logs that outline the specific issues encountered during testing, such as syntax errors, runtime exceptions, logical errors, or security vulnerabilities. The code generator 130 is operatively coupled to the code tester 132, integrated within the AI engine 128. Code testing refers to running each line of code with a controlled input, and verifying if it performs the expected output. The goal is to identify bugs or errors in the codes and correct them to generate the actual application needed by the user. There are three types of testing performed by the code tester 132, namely, unit testing, integration testing, and end-to-end testing.

Unit Testing is the process of testing individual units of code, such as functions or classes. For instance, in React, the common pattern is to divide the UI into smaller parts called Sections, namely, boilerplate, jigsaw pieces, and context.

Integration Testing refers to a type of software testing that focuses on verifying the interactions and communication between different components, modules, or subsystems of a software system. It aims to ensure that the integrated components work together as expected and that the overall system functions correctly. The primary goal of this type of testing is to identify defects or issues that may arise when different components are combined and interact with each other. By testing the integration points and data flow between components, Integration Testing helps uncover errors such as incompatible interfaces, incorrect data transfer, communication failure, and so on.

End-to-end Testing verifies that the application is working correctly from the beginning to the end of a particular user flow. It replicates expected user behavior and various usage scenarios to ensure that your application works as a whole. It uses a production-equivalent environment, as well as, data to simulate real-world situations, and may also involve the integrations your software has with external applications. For instance, ‘Is the button disabled after the X action?’, ‘Does the application mute after X time?’, and so on. The End-to-end Testing can be performed at various levels, including, component integration testing, API integration testing, database integration testing, and system integration testing.

In operation 214, the document management platform 106 presents a generated application 134 to the user along with the application code used to create the application.

The document management platform 106 serves as the final destination where the generated application 136, along with its corresponding application code snippet and description 138, is presented to the user. This online document management platform 106 provides an interactive user interface 108, allowing users to engage with the generated application 136. Upon receiving the generated application 136, the user is not only able to see the application 136 in its functional form but is also provided access to the underlying application code snippet and description 138 that was used to create it. This dual presentation enables users to understand how the application 136 is designed.

The interactive interface empowers users with multiple options, including the ability to review the application code line-by-line, test the application's features, and ensure it meets their requirements. Users can request modifications directly through the user interface 108 by prompting the chatbot 110 to make necessary adjustments to either the application or the code based on feedback. Additionally, the online document management platform 106 offers the flexibility to download the application code, allowing users to further customize and refine the code in their preferred development environments.

An exemplary code used by the application generation system 100 to present the generated application is given below:

```
import asyncio
import json
import logging
from typing import Dict, Any, Callable, AsyncGenerator, Union, AsyncIterator
from fastapi.responses import StreamingResponse
logger = logging.getLogger(“antenna.services.event_stream”)
class EventStream:
  def _{——}init_{——}(self):
    self.queue = asyncio.Queue( )
    self.is_done = False
async def put(self, event: Dict[str, Any]):
    logger.debug(f“Putting event into queue: {event}”)
    await self.queue.put(event)
    if event.get(‘is_final’, False):
      self.is_done = True
  async def _{——}aiter_{——}(self) −> AsyncIterator[Dict[str, Any]]:
    while not self.is_done:
      try:
        event = await asyncio.wait_for(self.queue.get( ), timeout=0.1)
        logger.debug(f“Yielding event from queue: {event}”)
        yield event
        if event.get(‘is_final’, False):
          break
      except asyncio.TimeoutError:
        continue
def stream_llm_events(session_id: Union[str, Callable[[ ], str]]):
  def decorator(func: Callable):
    async def wrapper(*args, **kwargs) −> StreamingResponse:
      async def event_generator( ) −> AsyncGenerator[str, None]:
        async for event in func(*args, **kwargs):
          if event is None: # None is our signal to stop the
stream
            break
          yield f“data: {json.dumps(event)}\n\n”
      actual_session_id = session_id( ) if callable(session_id) else
session_id
      return StreamingResponse(event_generator( ),
media_type=“text/event-stream”, headers={“X-Session-ID”: actual_session_id})
    return wrapper
return decorator
```

The provided code defines an asynchronous event streaming mechanism using Python's asyncio and FastAPI. The EventStream class manages events using an asynchronous queue. It allows events to be added via the put method and iterates over events asynchronously until a final event (indicated by is_final) is encountered. The stream_llm_events function is a decorator that wraps a function to generate server-sent events (SSE) by streaming JSON-formatted events through FastAPI's StreamingResponse. The decorator can handle session IDs, either as a static value or generated by a callable, and uses an asynchronous generator to yield events as server-sent event messages, allowing real-time event streaming to the user.

The pseudo-code used in the application generation system 100 that utilizes documents ingested by the user in an online document management platform 106 is given below:

```
function parseText(document):
  return extracted_text
function assignMetadata(text):
  metadata = analyzeText(text)
  return metadata
function constructGraph(data_points):
  graph = new Graph( )
  for data in data_points:
    graph.addNode(data)
    for related_data in findRelations(data):
      graph.addEdge(data, related_data)
  return graph
function summarizeDocument(text, level_of_detail):
  summary = generateSummary(text, level_of_detail)
  return summary
```

The application generation system 100 further comprises a feedback module 136, operatively coupled with the AI engine 128 and the online document management platform 106. The feedback module 136 continuously refines the generated application code by iteratively analyzing both the application code and user feedback. The feedback module 136 evaluates the performance of the application against user requirements and identifies the areas for improvement. Based on this analysis, the feedback module 136 adjusts the prompts used by the AI engine 136, enhancing its accuracy and relevance. This iterative process allows the AI engine 128 to learn from each feedback cycle, improving code quality and aligning the generated application more closely with user needs. The feedback loop ensures that the AI engine 128 evolves dynamically, adapting to changes and delivering increasingly precise outputs over time as per user's needs.a

In an embodiment, the application generation system 100 can utilize the shortcuts given below to access various API bundles 116 to perform the corresponding task:

/account
# Existing endpoints

| | | |
|---|---|---|
| POST | /account/login | - User login |
| POST | /account/logout | - User logout |
| GET | /account/profile | - Get user profile |
| PUT | /account/profile | - Update user profile |
| POST | /account/register | - Register new user |
| POST | /account/verify | - Verify user account |
| POST | /account/reset-password | - Reset password |

# Global Account Preferences

| | | |
|---|---|---|
| GET | /account/preferences/global | - Get all global |

preferences

| | | |
|---|---|---|
| PUT | /account/preferences/global | - Update all global |

preferences

| | | |
|---|---|---|
| GET | /account/preferences/global/{pref_key} | - Get specific global |

preference

| | | |
|---|---|---|
| PUT | /account/preferences/global/{pref_key} | - Update specific |

global preference
# User-specific Preferences

| | | |
|---|---|---|
| GET | /account/preferences/{user_id} | - Get all user-specific |

preferences

| | | |
|---|---|---|
| PUT | /account/preferences/{user_id} | - Update all user- |

specific preferences

| | | |
|---|---|---|
| GET | /account/preferences/{user_id}/{pref_key} | - Get specific user |

preference

| | | |
|---|---|---|
| PUT | /account/preferences/{user_id}/{pref_key} | - Update specific user |

preference
# LM Model Preferences

| | | |
|---|---|---|
| GET | /account/preferences/lm-model | - Get all LM model |

preferences

| | | |
|---|---|---|
| PUT | /account/preferences/lm-model | - Update all LM model |

preferences

| | | |
|---|---|---|
| GET | /account/preferences/lm-model/{model_key} | - Get specific LM model |

preference

| | | |
|---|---|---|
| PUT | /account/preferences/lm-model/{model_key} | - Update specific LM |

model preference
# External service connectors

| | | |
|---|---|---|
| GET | /account/connectors | - List all connected services |
| POST | /account/connectors | - Add a new service connector |
| GET | /account/connectors/{service} | - Get details of a specific connector |
| PUT | /account/connectors/{service} | - Update a specific connector |
| DELETE | /account/connectors/{service} | - Remove a specific connector |

# OAuth flow for external services?

| | | |
|---|---|---|
| GET | /account/connectors/{service}/auth | - Initiate OAuth flow |
| GET | /account/connectors/{service}/callback | - OAuth callback URL |

# Sharing connectors between users?

| | | |
|---|---|---|
| POST | /account/connectors/{service}/share | - Share a connector with |

another user

| | | |
|---|---|---|
| GET | /account/connectors/shared | - List shared connectors |
| POST | /account/connectors/shared/{id}/accept | - Accept a shared connector |
| POST | /account/connectors/shared/{id}/reject | - Reject a shared connector |

Library
/library
# Document Management

| | | |
|---|---|---|
| GET | /library/documents/ | - List all documents (with |

filtering options)

| | | |
|---|---|---|
| POST | /library/documents/ | - Add a new document manually |
| GET | /library/documents/{document_id} | - Get a specific document |
| PUT | /library/documents/{document_id} | - Update a document |
| DELETE | /library/documents/{document_id} | - Delete a document |

# Search

| | | |
|---|---|---|
| POST | /library/search | - Search documents (text, |

tags, priority, etc.)
# Priority and Rating

| | | |
|---|---|---|
| GET | /library/documents/{document_id}/priority | - Get document |

priority

| | | |
|---|---|---|
| POST | /library/documents/{document_id}/priority | - Set priority |

(admin/owner only)

| | | |
|---|---|---|
| POST | /library/documents/{document_id}/vote/up | - Upvote a |

document

| | | |
|---|---|---|
| POST | /library/documents/{document_id}/vote/down | - Downvote a |

document

| | | |
|---|---|---|
| DELETE | /library/documents/{document_id}/vote | - Remove user's |

vote

| | | |
|---|---|---|
| GET | /library/documents/trending | - Get trending |

documents based on recent votes
# Tags

| | | |
|---|---|---|
| GET | /library/tags | - List all tags |
| POST | /library/tags | - Create a new tag |
| DELETE | /library/tags/{tag_id} | - Delete a tag |
| PUT | /library/documents/{document_id}/tags | - Update tags for a document |

# Statistics

| | | |
|---|---|---|
| GET | /library/stats | - Get library statistics |

Ingest
/library/ingest

| | | |
|---|---|---|
| POST | /library/ingest | - Start ingestion process |

(main endpoint)

| | | |
|---|---|---|
| GET | /library/ingest/status/{job_id} | - Get ingestion job status |
| POST | /library/ingest/cancel/{job_id} | - Cancel ingestion job |

# Target-specific ingestion and strategies

| | | |
|---|---|---|
| GET | /library/ingest/targets | - List available ingestion |

targets

| | | |
|---|---|---|
| GET | /library/ingest/targets/{target}/strategies | - List strategies for a |

specific target
# Configuration

| | | |
|---|---|---|
| GET | /library/ingest/config | - Get current ingestion |

configuration

| | | |
|---|---|---|
| PUT | /library/ingest/config | - Update ingestion |

configuration
# Source-specific ingestion (optional, for direct source ingestion)

| | | |
|---|---|---|
| POST | /library/ingest/sources/gdrive | - Ingest from Google Drive |
| POST | /library/ingest/sources/onedrive | - Ingest from OneDrive |
| POST | /library/ingest/sources/s3 | - Ingest from AWS S3 |

Retrieve
/library/retrieve

| | | |
|---|---|---|
| POST | /library/retrieve | - Combined muli-functional |

search

| | | |
|---|---|---|
| GET | /library/retrieve/config | - Get retrieval configuration |
| PUT | /library/retrieve/config | - Update retrieval |

configuration
# Target-specific retrieval

| | | |
|---|---|---|
| POST | /library/retrieve/vector | - Query vector database |
| POST | /library/retrieve/graph | - Query graph database |

# Document retrieval

| | | |
|---|---|---|
| GET | /library/retrieve/document/{doc_id} | - Retrieve a specific document |

# Retrieval strategies

| | | |
|---|---|---|
| GET | /library/retrieve/strategies | - List available retrieval |

strategies
Interact
/interact

| | | |
|---|---|---|
| POST | /interact | - Main interaction endpoint |

(default)

| | | |
|---|---|---|
| GET | /interact/history | - Get interaction history |

/chat

| | | |
|---|---|---|
| POST | /interact/chat/start | - Start a new chat session |
| POST | /interact/chat/{session_id} | - Continue an existing chat |

session

| | | |
|---|---|---|
| GET | /interact/chat/{session_id} | - Retrieve a chat session |
| DELETE | /interact/chat/{session_id} | - End and delete a chat |

session
/tasks

| | | |
|---|---|---|
| POST | /interact/tasks/execute | - Execute a task |
| GET | /interact/tasks | - List all tasks (with |

filtering options)

| | | |
|---|---|---|
| GET | /interact/tasks/{job_id} | - Get details of a specific |

task

| | | |
|---|---|---|
| POST | /interact/tasks/{job_id}/cancel | - Cancel a running task |
| POST | /interact/tasks/{job_id}/pause | - Pause the task |
| POST | /interact/tasks/{job_id}/resume | - Resume the task |

/research

| | | |
|---|---|---|
| POST | /interact/tasks/research | - Start a research task |
| GET | /interact/tasks/research/{job_id} | - Get research results |

/artifacts

| | | |
|---|---|---|
| POST | /interact/tasks/artifacts | - Generate an artifact |

(e.g., code)

| | | |
|---|---|---|
| GET | /interact/tasks/artifacts/{artifact_id} | - Retrieve a generated |

artifact

| | | |
|---|---|---|
| GET | /interact/tasks/artifacts/templates | - Retrieve available |

templates

| | | |
|---|---|---|
| POST | /interact/tasks/artifacts/generate | - Generate artifact |

code by template

| | | |
|---|---|---|
| POST | /interact/tasks/artifacts/sandbox | - Get/Create Sandbox |

given template
/text

| | | |
|---|---|---|
| POST | /interact/tasks/text | - Perform a text-based |

task (including queries, summarization, translation, etc.)

| | | |
|---|---|---|
| GET | /interact/config | - Get interaction |

configuration (proxy to account preferences)

| | | |
|---|---|---|
| PUT | /interact/config | - Update interaction |

configuration (proxy to account preferences)

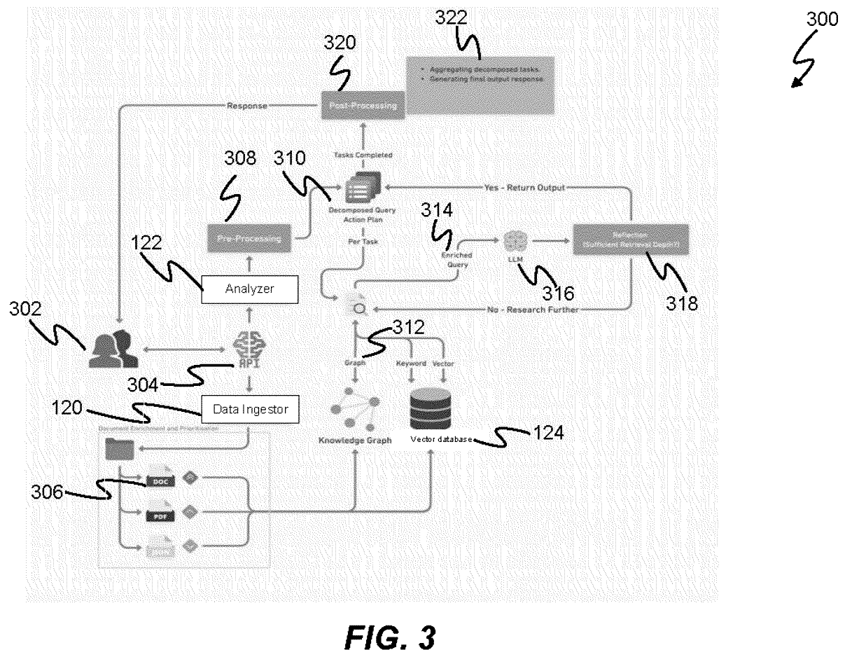

FIG. 3 depicts an exemplary ingested documents processing system 300, which is an embodiment of the document ingestion system 100 that manages documents and generates an application using a user query of FIG. 1.

The ingested documents processing system 300 begins with a user 302 uploading documents 306 from either local storage 112 or cloud storage 114 to the online document management platform 106. These documents 306 can include various formats such as PDFs, Word files, and emails. Once uploaded, the documents 306 are sent to the data ingestor 120 through API bundles 304, which provide the system 300 access to the folder containing the documents 306.

The data ingestor 120 is responsible for receiving and organizing the ingested documents 306. After ingestion, the documents 306 are passed using the analyzer 122. During the pre-processing phase 308, the documents undergo parsing, which filters relevant content from the ingested documents 306. Following parsing, the analyzer 122 generates an action plan 310 containing insights derived from the analyzed documents. For example, if the documents pertain to a business project, the action plan may highlight key themes, topics, or actionable steps for business growth. This analysis leads to the creation of a vector database 124, generated through embedding and chunking the analyzed documents. Embedding transforms the document content into numerical vectors, allowing the system to perform efficient searches, categorization, and ranking.

A knowledge graph 312 is then generated, illustrating the relationships and connections between various entities, concepts, or documents, thus aiding users in understanding the context and interconnections within the uploaded content. A prompt generator 126 uses rules and guidelines from a prompt engineer to create an enriched query 314, enhancing user search and interaction capabilities by refining prompts based on the analyzed documents.

This enriched query or prompt is processed by a large language model (LLM) 316, which interprets it and generates intelligent responses. The ingested documents processing system 300 then undergoes a reflection phase 318 and post-processing 320 to ensure that the response is coherent, accurate, and meets user expectations. Finally, the code generator 130, integrated within the AI engine 128, generates an application as final output 322 in correspondence to the user's query, by utilizing the analyzed, prioritized content and insights from the knowledge graph 312 and vector database 124.

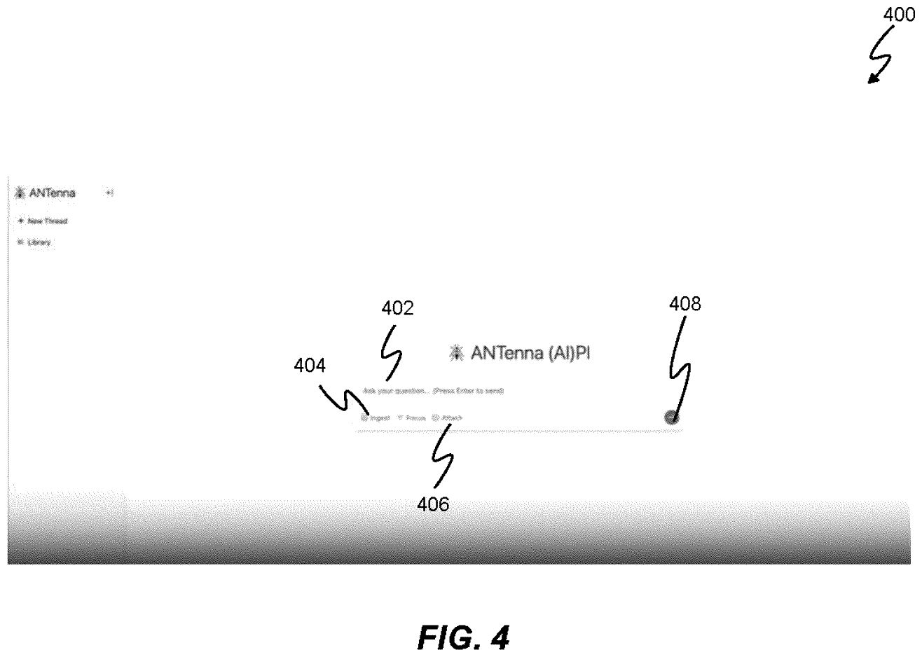

FIG. 4 depicts an exemplary user interface 400 where the user can either directly enter the query or ingest documents along with the query to get the result as per user requirements.

The user interface 400 displays the front page of the online document management platform 106. Upon logging on to the online document management platform 106, the user gets access to the user interface 400. The user can perform a plurality of tasks using the user interface 400, which includes, direct query submission without document ingestion, query submission along with document ingestion, only document ingestion, and so on.

The user can utilize the chatbot 110 integrated within the user interface 400 to type the query on tab 402. Further, the user can ingest and attach documents by clicking on the tabs 404 and 406 respectively. Finally, an arrow 408 is shown, using which the user can ask the online document management platform 106 to perform that task.

For instance, the user query may include:

```
{
  “namespace”: “drive_1ya3gwhzbo-eiit6sykkxulmaey-ufkid”,
  “query”: “Please generate an app that selects a course for the user and
generates a test based on the selected course.”
}
```

Further, the document ingestion includes providing a link to the folder where the documents are stored. It could be local storage 112, within the device, or cloud storage 114, like Google Drive, AWS S3, Microsoft One Drive, and so on. Like in the case of the above example of the user query, the link of the folder to be ingested is: drive_1ya3gwhzbo-eiit6sykkxulmaey-ufkid

In this way, it becomes very easy for the user to directly enter the query and upload the documents in the online document management platform 106 and receive a response instantly.

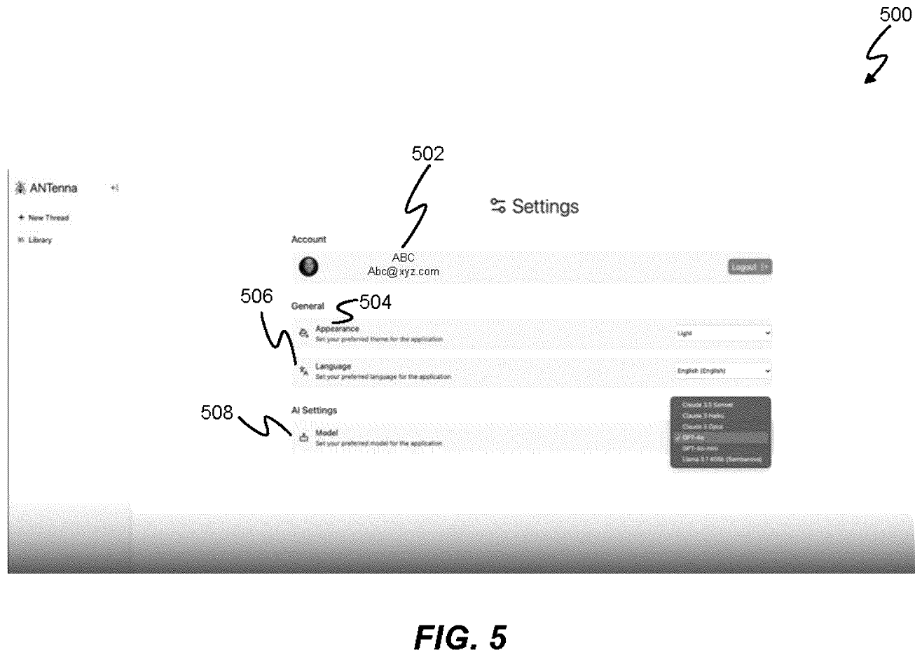

FIG. 5 depicts an exemplary user interface 500 that allows the user to change the settings of the online document management platform 106.

Upon clicking on the settings button given in the user interface 400, the user can access the settings of the online document management platform 106 and can make changes in the settings as per their requirements. The user interface 500 displays the settings of the online document management platform 106. The user details like name, photo, and email ID are mentioned in tab 502. The user can adjust the general settings like the appearance and the language of the online document management platform 106. The appearance can be adjusted by clicking on tab 504, which involves a dropdown menu, including dark theme, light theme, colored theme, and so on. Similarly, the user uses the language settings by clicking on tab 506, which includes language selections like English (US), Hindi, English (UK), Chinese, and so on.

Further, the user can adjust the AI model settings, using which the user can select the AI engine 128 that they wish to use for completing the task prescribed by the user. The user can click on tab 508 to select the AI engine 128, as per their need. The settings include a dropdown menu where a plurality of AI tools are shown, which can be selected by the user. For instance, the AI tools mentioned in the dropdown menu include Claude 3.5 Sonnet, Claude 3 Haiku, GPT-4o, GPT-4o mini, Llama 3.1 405b Sambanova, and so on.

Claude 3.5 Sonnet is a model designed for generating detailed, structured responses, particularly effective for creative tasks like poetry or writing in constrained formats. Claude 3 Haiku is a more compact version, best suited for short, concise answers, especially useful in scenarios where brevity is key. GPT-4o is an optimized version of GPT-4, offering balanced performance across various tasks like problem-solving and conversation. GPT-4o mini is a lighter, faster variant of GPT-4o, ideal for quicker interactions and less complex tasks. Llama 3.1 405b, by Meta, is a powerful language model intended for both research and industrial applications, especially for handling large-scale language generation. Sambanova focuses on AI hardware and software solutions, facilitating high-performance AI workloads for enterprise and specialized tasks.

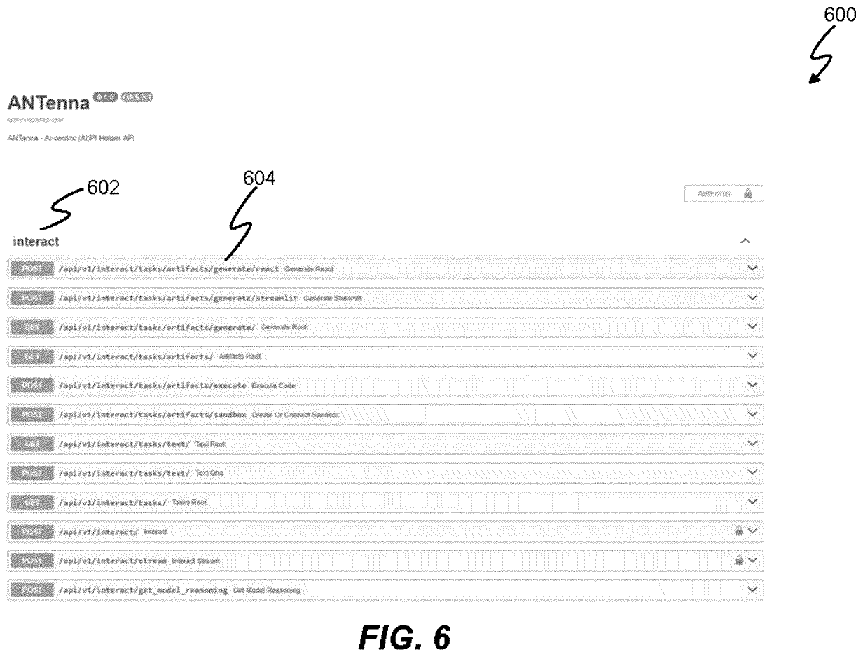

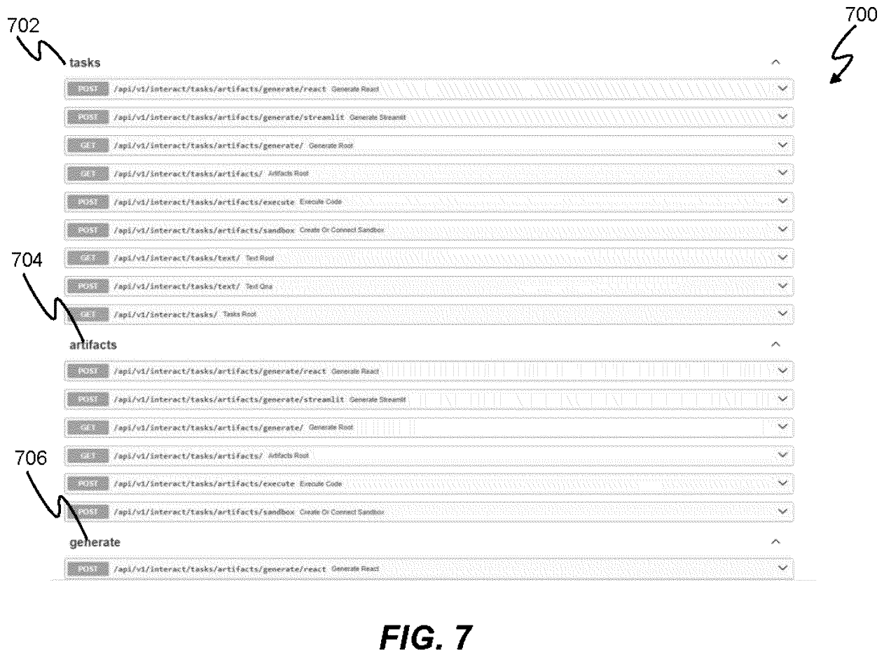

FIGS. 6 and 7 depict exemplary user interfaces displaying multiple API bundles using which the documents are ingested to the ingested document processing module 118 to process the user's query.

The user interface 600 discloses multiple API bundles categorized under different categories like interact 602, and so on. These categories include a plurality of API bundles within it to perform the task, as queried by the user. For instance, the task may include generating an application, generating a React Code, generating a Streamlit Code, and so on. The API bundles include the link to the folder provided by the user. The API bundles help in transmitting the document details from the corresponding folder to the data ingestor 120. For instance, an exemplary API bundle 604 includes ‘/api/v1/interact/task/artifacts/generate/React.’, where the user has queried to generate an application using React code. The user can click on the dropdown menu to enter the query.

React is a JavaScript library for building user interfaces and applications, especially for single-page applications, using reusable components, and managing dynamic data with state. React uses JSX, a syntax that blends HTML and JavaScript, to create interactive user interfaces and applications. On the other hand, Streamlit is a Python framework designed for quickly building web apps, particularly useful for data science and machine learning projects. The streamlit code allows users to create interactive elements like buttons and input fields with minimal code.

The user interface 700 discloses multiple API bundles categorized under different categories like tasks 702, artifacts 704, generate 706, and so on. These categories include a plurality of API bundles within it to perform the task, as queried by the user. For instance, the task may include generating an application, generating a React Code, generating a Streamlit Code, and so on.

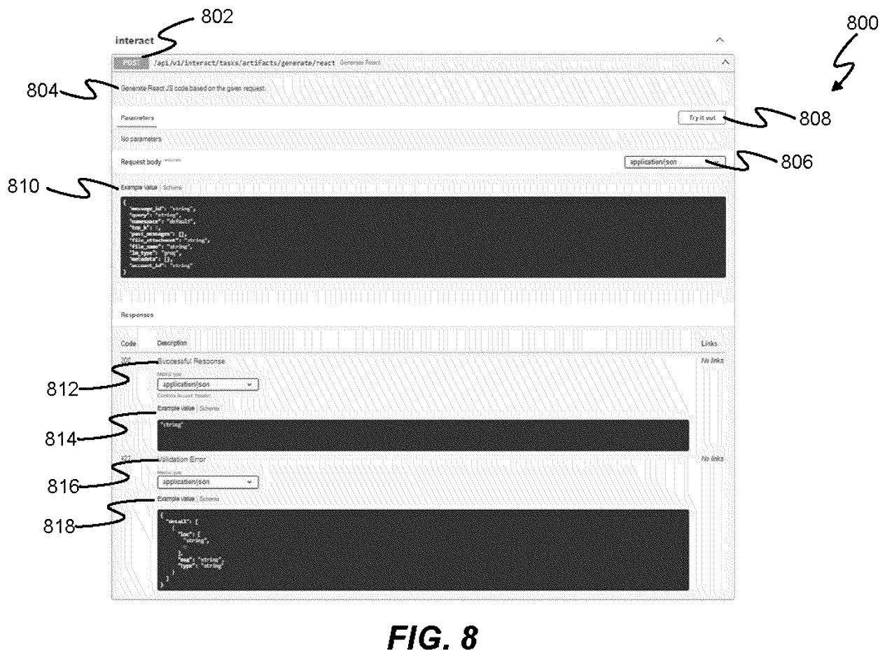

FIG. 8 depicts an exemplary user interface 800 that allows users to enter the query, for which the user needs a solution.

Upon clicking on the dropdown menu in the user interface 600, the user gets access to the user interface 800, where the user is allowed to enter the query. In the case of the present example, the user has accessed the dropdown menu of the API bundle ‘/api/v1/interact/task/artifacts/generate/React.’ 802, where the user has queried for the generation of a React Code 804.

The user can select the type of input that they wish to provide from the dropdown menu 806. For instance, in the case of the present example, it is application/JSON. The user can further enter the query in the tab example value 810. Upon successfully entering the query, the user can click on tab 808 ‘Try it out’ to execute the query.

Further, the user receives the response generated by the AI engine 128, which includes a heading and a detailed description. The user can access the heading and detailed description of the response on the tabs 814 and 818 respectively. Additionally, the user can select the format of the headings and the detailed description of the response by clicking on the dropdown menus 812 and 816 respectively.

For instance, a link of the cloud storage 114, for instance, Google Drive, in the case of the present example is provided to the data ingester 120 via., the API bundle 802 to retrieve a response to the user query. The function URL includes:

https://vlq3xj5ppiykcsacw4wij5rlci0qfkom.lambda-url.us-east-1.on.aws/

The input, i.e., the link of the cloud storage 114 provided by the user on the tab 810 is given below:

```
{
  “namespace”: “drive_1ya3gwhzbo-eiit6sykkxulmaey-ufkid”,
  “query”: “Generate an app that calculates the R&D expenses to qualify for
the Section 41 tax credit for ABC organization?”
}
```

The output generated based on the input provided by the user includes:

```
{
  ″message″: ″Success″,
  ″result″: {
    ″sources″: [
      {
        ″file_name″: ″Central Support - 2nd Brain NEW″,
        ″url″:
″https://docs.google.com/document/d/1vEANATZ38SIsuKtBus4TucpZLBLyVJw6ftm4X2hi
lqo/edit?usp=drivesdk″,
        ″mime_type″: ″application/vnd.google-apps.document″
      }
    ],
    ″response″: ″<text>\nThe note-taking app I'm about to generate will allow
users to create, edit, and save notes. The app will have a simple and
intuitive interface, making it easy for users to organize their thoughts and
ideas.\n\nHere's an overview of how the app will work:\n\n* Users can create
new notes by clicking on the \″New Note\″ button.\n* Each note will have a
title and a content area where users can type in their notes.\n* Users can
save their notes by clicking on the \″Save\″ button.\n* The app will display
a list of all saved notes, allowing users to easily access and edit their
previous notes.\n\nTo implement this app, I'll use React and Tailwind CSS for
styling. I'll create a ‘Note‘ component that will handle the creation,
editing, and saving of notes. The component will use React state to store the
note title and content.\n\nHere's an example of how the ‘Note‘ component
might look:\n‘‘‘jsx\nfunction Note( ) {\n const [title, setTitle] =
useState(′′);\n const [content, setContent] = useState(′′);\n\n const
handleSubmit = ( ) => {\n // Save the note to local storage or a database\n
};\n\n return (\n <div>\n <input\n type=\″text\″\n
value={title}\n onChange={(e) => setTitle(e.target.value)}\n
placeholder=\′′Note title\′′\n />\n <textarea\n
value={content}\n onChange={(e) => setContent(e.target.value)}\n
placeholder=\′′Note content\′′\n />\n <button
onClick={handleSubmit}>Save</button>\n </div>\n
);\n}\n‘‘‘\n</text>\n\<artifact>\n‘‘‘jsx\nimport React, { useState } from
′react′;\n\nfunction Note( ) {\n const [title, setTitle] = useState(′′);\n
const [content, setContent] = useState(′′);\n const [notes, setNotes] =
useState([ ]);\n\n const handleSubmit = ( ) => {\n const newNote = { title,
content };\n setNotes([...notes, newNote]);\n setTitle(′′);\n
setContent(′′);\n };\n\n const handleEdit = (index) => {\n const note =
notes[index];\n setTitle(note.title);\n setContent(note.content);\n
};\n\n const handleDelete = (index) => {\n setNotes(notes.filter((_, i)
=> i !== index));\n };\n\n return (\n <div className=\′′flex flex-col h-
screen p-4\′′>\n <h1 className=\′′text-2xl\′′>Note Taking App</h1>\n
<form onSubmit={(e) => e.preventDefault( )}>\n <input\n
type=\′′text\′′\n value={title}\n onChange={(e) =>
setTitle(e.target.value)}\n placeholder=\′′Note title\′′\n
className=\′′w-full p-2 mb-2\′′\n />\n <textarea\n
value={content}\n onChange={(e) => setContent(e.target.value)}\n
placeholder=\′′Note content\′′\n className=\′′w-full p-2 mb-2\′′\n
/>\n <button onClick={handleSubmit} className=\′′bg-blue-500 hover:bg-
blue-700 text-white font-bold py-2 px-4 rounded\′′>\n Save\n
</button>\n </form>\n <ul className=\′′list-none p-0 m-0\′′>\n
{notes.map((note, index) => (\n <li key={index} className=\′′mb-
2\′′>\n <h2>{note.title}</h2>\n <p>{note.content}</p>\n
<button onClick={( ) => handleEdit(index)} className=\′′bg-yellow-500 hover:bg-
yellow-700 text-white font-bold py-2 px-4 rounded\′′>\n Edit\n
</button>\n <button onClick={( ) => handleDelete(index)}
className=\′′bg-red-500 hover:bg-red-700 text-white font-bold py-2 px-4
rounded\′′>\n Delete\n </button>\n </li>\n
))}\n </ul>\n </div>\n );\n}\n\nexport default
Note;\n‘‘‘\n</artifact>″
  }
}
```

The output includes the details of an application generated by the user in JSON format. Further, the React code will be shown to the user along with the application generated, which can be accessed by the user to perform the function as needed.

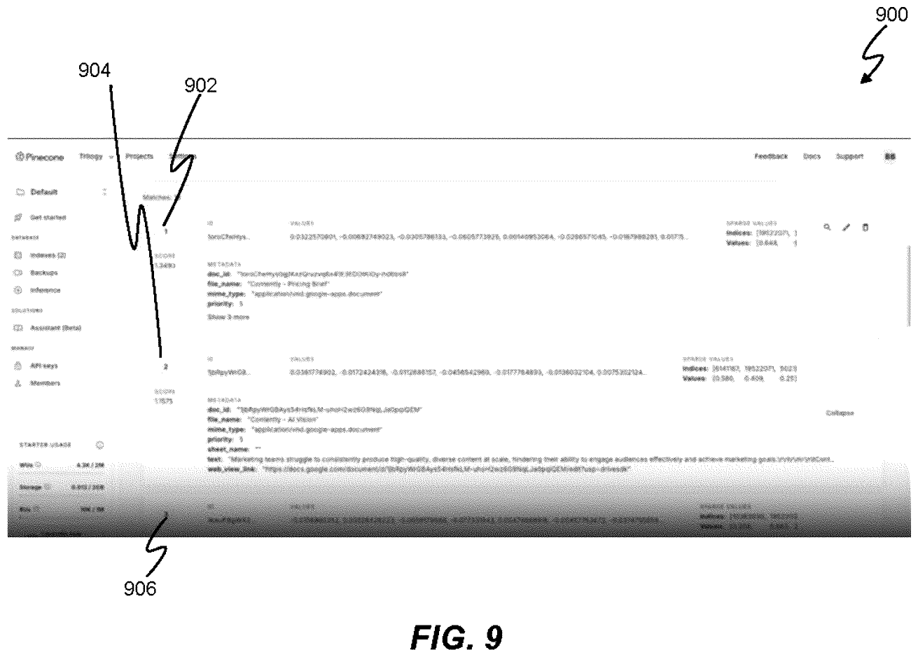

FIG. 9 depicts an exemplary vector database 900 that provides the details of the metadata divided into chunks.

The vector database 124 is created by converting the content of one or more analyzed documents into vectorized embeddings by converting all contextual data from the documents into numerical vectors that represent the semantic meaning of the text. The embedding utilizes machine learning algorithms to convert the textual content into vector embeddings, often represented in numerical format. These embeddings capture relationships between words, entities, and sections within the documents, making it easier to retrieve relevant information by understanding the semantic connections between different parts of the text.

In addition to embedding, the embedded documents are broken down into smaller, meaningful chunks such as sections, paragraphs, or topics. This is based on semantic analysis, ensuring that each chunk represents a coherent idea or subject. By dividing the document into smaller units, it becomes easier to process and retrieve specific information, enabling more precise and efficient querying of the data. This structure enhances the retrieval of information by not only storing raw text but also understanding the relationships and meaning within the document.

For instance, in the case of the present example shown in FIG. 9, a plurality of vector databases 902, 904, and 906 are shown. The vector database 902 includes details such as doc_id, file_name, mime_type, priority score, sheet_name, text, and web_view_link. The vector database 902 also includes sparse values, including indices and values. Also, the vector database 902 includes the converted numerical values.

The vector database 902 is a wide-ranging data repository that stores various types of metadata and numerical representations of documents or content. The vector database 902 includes several essential fields that help to organize and retrieve data efficiently. These fields include doc_id, which serves as a unique identifier for each document, and file_name, the name given to the file for easy identification. The mime_type field specifies the format of the file, indicating whether it is a text, image, or other file type. Additionally, the vector database 902 tracks a priority score, which may be used to rank or prioritize certain documents for retrieval based on importance or relevance. For documents stored in spreadsheet formats, the sheet_name field identifies the specific sheet within the document. The text field contains the textual content of the file, allowing for easy search ability within the vector database. The web_view_link provides a URL or direct link to view the document in a web interface, enhancing accessibility.

In addition to the metadata, the vector database 902 includes sparse values, which consist of pairs of indices and their corresponding values. These sparse values are typically representations of document features, where only non-zero or significant data points are stored, optimizing memory usage and processing speed. The inclusion of both sparse values and dense embeddings ensures that the vector database 902 supports flexible, scalable, and precise data retrieval and analysis across a wide range of applications.

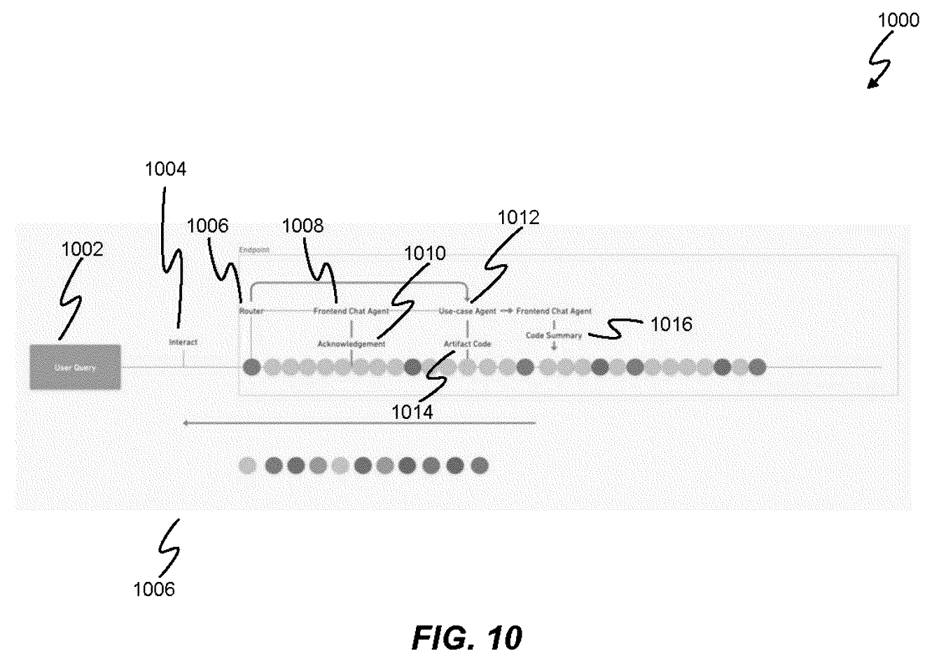

FIG. 10 depicts an application streaming process 1000, which is an embodiment of the application generation process 200 that utilizes documents ingested by the user in an online document management platform 106 of FIG. 2.

The application streaming process 1000 handles user interactions, processes user queries, and manages various elements like text, code, and media within a chat-based environment. The application streaming process 1000 begins with the User Query 1002, which represents the initial input from the user. The user query 1002 is the starting point of the interaction, setting off a series of actions within the online document management platform 106. Next, Interact 1004 processes the user query by validating it and preparing it for further handling. The Router 1006 then directs the query to the analyzer 122 (not shown in the figure), deciding which backend services or modules should manage the request based on predefined routing logic. The Frontend Chat Agent 1008 manages the user-facing interface, handling the display of messages and responses to keep the user engaged.

Once the query 1002 is received and processed, an Acknowledgement 1010 is sent to the user, confirming that their user query 1002 has been received and is being worked on by the analyzer 122. This acknowledgment helps maintain communication flow and assures the user of ongoing progress. Meanwhile, User Case Agent 1012 manages session-specific data, ensuring the interaction is personalized and contextually relevant by tracking user-specific information throughout the chat session. The generated code in response to the user's query 1002 is referred to as Artifact Code 1014, which includes executable scripts, configurations, or other programming elements designed to meet the user's needs. Accompanying this is the Code Summary 1016, which provides a concise explanation of the generated code, helping users understand its purpose and functionality.

Each chat session is uniquely identified by a Chat ID, which tracks the sequence of messages exchanged between the user and the online document management platform 106. Individual messages within the chat are identified by a Message ID, which helps in organizing and managing the flow of information. Each message may contain various elements such as text, code blocks, or multimedia, and these are further specified by the (Element) Type ID, which categorizes the type of content, like text, inline code, sources, or artifacts such as images, audio, and video. Each specific piece of content within a message is identified by an Element ID, ensuring that every element is distinct and correctly referenced.

Possible element types include standard Chat/Text, which represents plain text responses or queries, and Chat/Inline Code Block, which allows code snippets to be directly embedded within messages. Sources provide citations or references that support the content, enhancing the informational value of the chat. Artifact/Code represents code generated during the interaction, often linked to a code summary that explains its role. Additional element types encompass other forms of media, such as Images, Audio, and Video, adding richness and interactivity to the chat session.

The code used in the application streaming process 1000 is given below:

```
await event_stream.put(
  {
      “chat_id”: session_id,
      “message_id”: message_id,
      “element_id”: element_id,
      “type_id”: type_id,
      “chunk”: chunk,
      “is_final”: i == len(chunks) − 1
    }
)
```

The code explains how an event stream processes messages containing various elements. The event stream manages real-time data transmission, ensuring each message is correctly formatted and sent. In this context, the event stream system handles breaking down and sending elements piece-by-piece (chunks), ensuring each piece is transmitted in sequence until the final chunk is reached (is_final). This approach supports the smooth flow of complex, multi-part messages in a chat session.

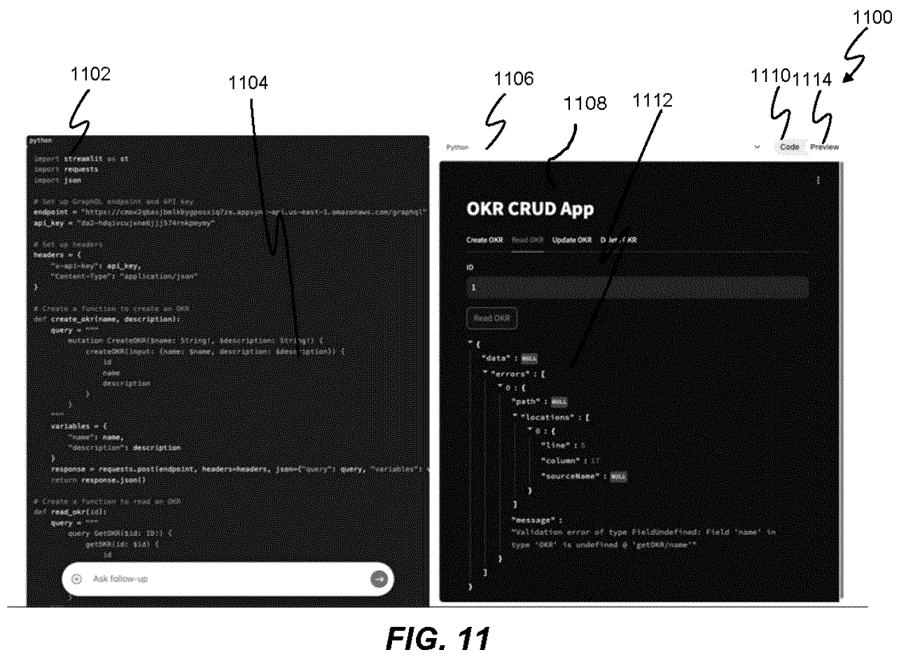

FIGS. 11-13 depict various applications generated by the application generation system that utilizes documents ingested by the user in an online document management platform 106, based on the user queries.

In the case of FIG. 11, the user submits the query stating, “Can you please create an CRUD app” 1102. Based on the query provided by the user an application code 1110 is generated which is written in Python 1106 language. The React code 1104 using which the application code 1110 is generated is provided on the left side of the user interface 1200.

The generated application ‘OKR CRUD App’ 1108 appears on the right side of the user interface 1100. The user can access the application code 1110 by clicking on the tab 1112 ‘Code’, and the user can also access the generated application 1108 by clicking on the tab 1114 ‘Preview’.

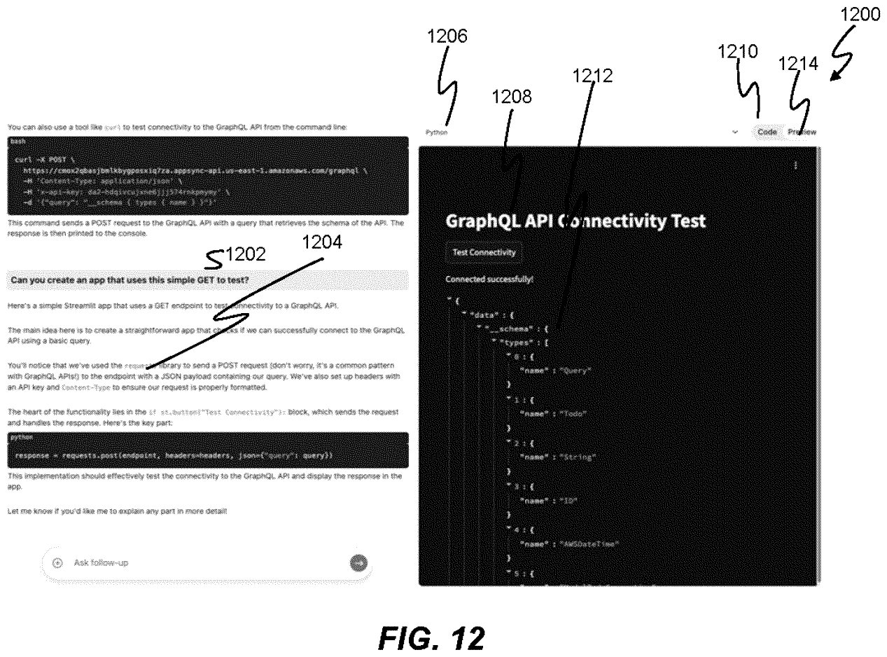

In the case of FIG. 12, the user submits the query stating, “Can you please create an app that uses this simple GET to test” 1202. Based on the query provided by the user an application code 1210 is generated which is written in Python 1206 language. The detailed explanation 1204 of the application code 1210 is provided on the left side of the user interface 1200.

The generated application ‘GraphQLAPI Connectivity Test’ 1208 appears on the right side of the user interface 1200. The user can access the application code 1210 by clicking on the tab 1212 ‘Code’, and the user can also access the generated application 1208 by clicking on the tab 1214 ‘Preview’.

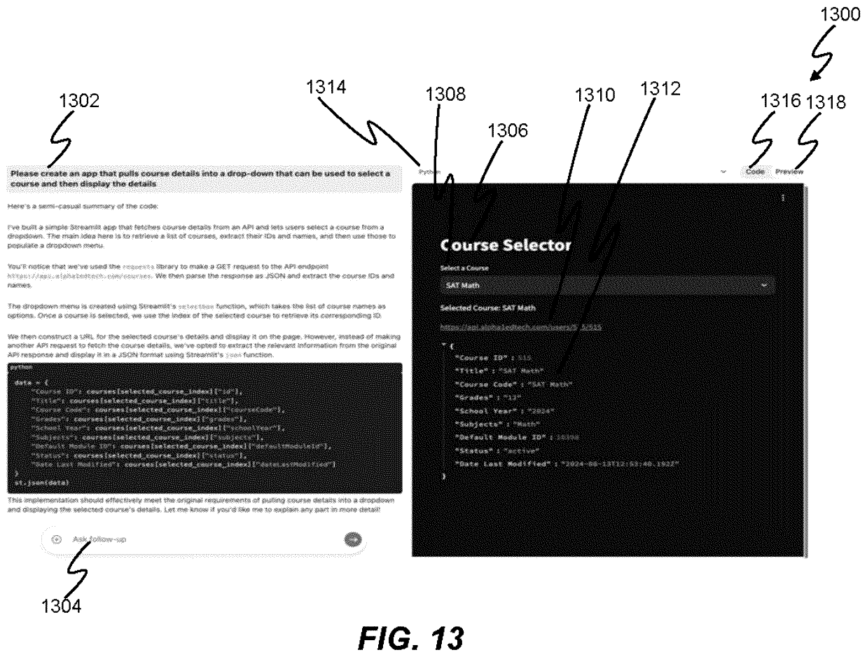

The user submits a query via a chatbot 1304, as shown in user interface 1300 of FIG. 13, asking to create an application 1306 that pulls course details into a drop-down menu for easy selection and displays the corresponding course information. The query 1302, such as ‘Please create an app that pulls course details into a drop-down that can be used to select a course and then displays the details’, is processed by the AI engine 128. Based on this request, the AI engine 128 generates Streamlit code 1312, a Python-based framework ideal for creating web applications, to build an application named ‘Course Selector’ 1306. This application 1306 provides an interactive interface where the user can select a course from a drop-down menu labeled ‘Select a course’ 1308. In the given example, the course ‘SAT Maths’ is chosen from the drop-down.

To create this application 1306, the AI engine 128 uses documents provided by the user, accessed through an API link 1310. These documents contain the necessary course details, which are dynamically loaded into the drop-down menu. The application 1306 then displays the selected course's relevant information once a course is chosen, making it an efficient tool for users to browse and learn about different courses.

The application 1306 offers several additional features to enhance usability. On the top-right corner of the screen, there are two tabs labeled ‘Code’ 1316 and ‘Preview’ 1318. These allow the user to either view the underlying code that was generated to build the application 1306 or preview the actual functioning of the application 1306. This dual view enables users to see both the technical backend and the frontend result of their query. Furthermore, the user can also choose the programming language in which the code is generated by selecting from a drop-down menu 1314 located at the top of the interface. On the left side of the screen, the Streamlit code 1312 used to generate the application 1306 is displayed, providing transparency into how the AI engine 128 created the application 1306. This setup allows the user not only to interact with the app but also to understand and modify the code behind it. The user can make changes in application 1306, if the generated application 1306 is not as per the user's requirements by providing an additional query via., the chatbot 1304.

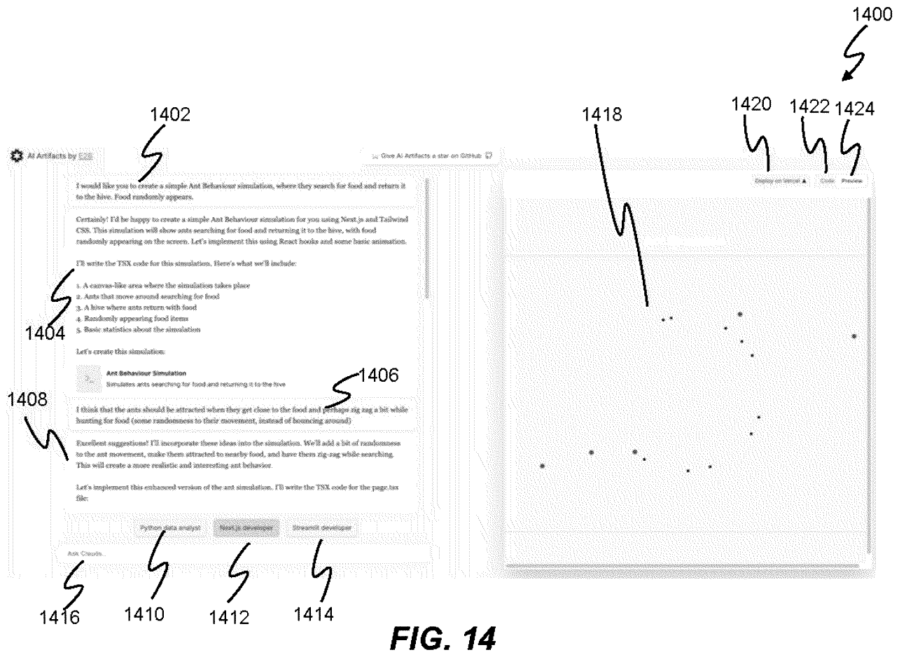

FIG. 14 depicts an exemplary knowledge graph 1418 generation based on the input queries provided by the user.

The application generation system 100 includes automatically generating the knowledge graph 1418 related to prioritized documents involving creating a visual and data-driven representation that maps out the relationships, relevance, and interconnections between these documents. This knowledge graph 1418 serves as a structured way to organize and understand how various documents relate to one another based on their content. The prioritization of documents, typically determined by factors like relevance, importance, or freshness, determines which documents are featured most prominently in the graph. The knowledge graph 1418 highlights these relationships by connecting documents that share common themes, entities, or concepts, making it easier for users to navigate through the information and gain insights into the overall document structure.

The knowledge graph 1418 is constructed by analyzing the entities (such as people, places, or organizations) and concepts (such as ideas, themes, or topics) found within the documents. These entities and concepts are identified using natural language processing (NLP) techniques and form the nodes in the graph, while the relationships between them become the edges linking these nodes

Moreover, the knowledge graph 1418 is dynamic, meaning it evolves as new documents are ingested or existing ones are updated. When new documents are added, the analyzer 122 automatically analyzes their content, identifies relevant entities and concepts, and integrates them into the existing graph by creating new nodes and edges or updating existing ones. Similarly, if documents are modified or updated, the knowledge graph 1418 reflects these changes in real-time, ensuring that the interconnections and relevance of the documents are always accurate and up-to-date. This dynamic updating capability ensures that the knowledge graph 1418 remains an active and reliable tool for visualizing and understanding the ongoing flow of information.

For instance, in the case of the present example 1400, the user has queried 1402 on the online document management platform 106, stating, ‘I would like you to create a simple ant behavior simulation for food and return it to the hive. Food randomly appears.’ Based on the query 1402 provided by the user via., a chatbot 1416, integrated within the online document management platform 106, the knowledge graph 1418 is created. The detailed explanation 1404 of the knowledge graph and the generated TSX code is provided to the user, to create a better and technical understanding of the generation of the knowledge graph 1418.

In the case of the present example, the generated knowledge graph 1418 is not upto the expectations to the user, so the user provides another query 1406, stating, ‘I think that the ants should be attracted when they get close to the food and perhaps zigzag a bit while hunting for food (some randomness to their movement, instead of bouncing around).’ Based on the query 1406 provided by the user via., a chatbot 1416, integrated within the online document management platform 106, the updated knowledge graph 1418 is created. The explanation 1408 is also generate in response to another query 1406.

The user has the freedom to choose the type of language for generating the application code, like Python 1410, Next.js 1412, and Streamlit 1414. The user can click on the corresponding tab to select the respective language. Further, the user can click on the tab ‘Display’ 1420, ‘Code’ 1422, and ‘Preview’ 1424 to have a look at the knowledge graph 1418, access the application code used for the generation of the knowledge graph 1418, and the generated application on the ant behavior simulation respectively.

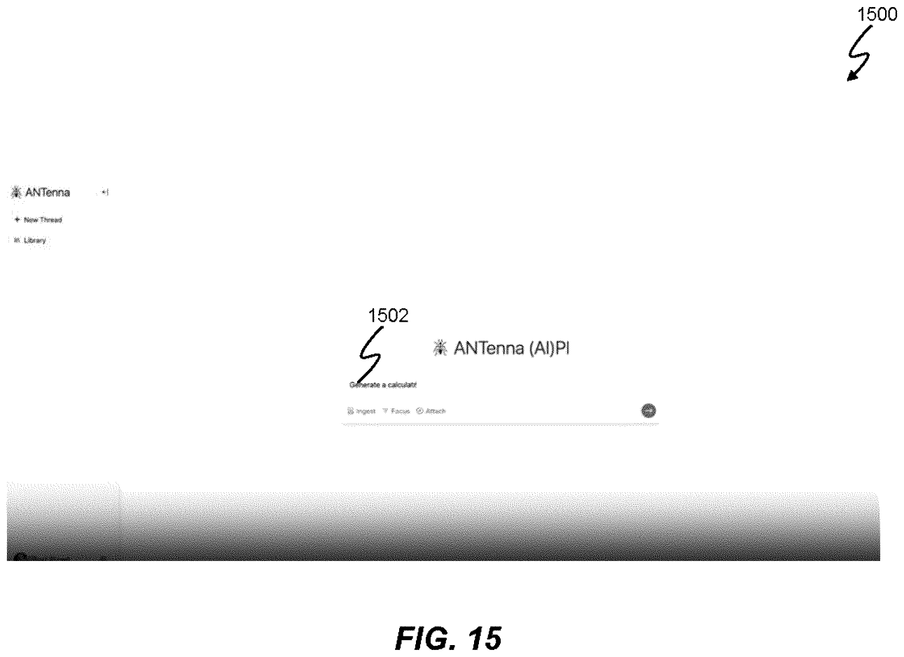

FIG. 15 depicts a user interface 1500 in which the user provides a query on the online document management platform 106 to generate a calculator application.

In the case of the present example, the user has directly provided query 1502 to the online document management platform 106 by entering query 1502 on the chatbot 110 of the online document management platform 106. For instance, in the case of the present example, the user query 1502 states, “Generate a calculator application”.

The user has yet to ingest any documents from the local storage 112 and cloud storage 114. This shows that the application generation system 100 also allows application generation based on user query 1502. Hence, it is easier for the user to generate an application of his/her choice.

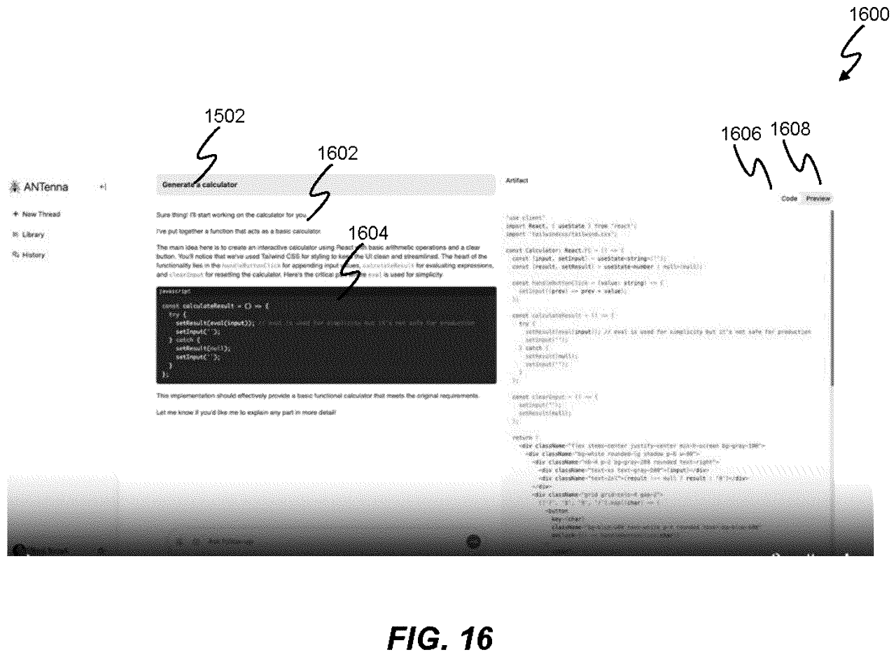

FIG. 16 depicts a user interface 1600 showing the AI-generated application code 1604 to generate the application.

Upon entering the query ‘Generate a calculator’ 1502 by the user on the online document management platform 106, the user gets access to the user interface 1600. The user interface 1600 displays the generated application code 1604 along with the detailed description 1602 of the application code 1604, i.e., how the code generator 130 has been used to create the application code 1604.

The user may either see the application code 1604 or the generated application by clicking on the tabs 1606 and 1608 respectively. When the user clicks on the tab 1606, the user gets access to the application code 1604 and when the user clicks on the tab 1608, the user gets access to the generated application. The detailed description 1602 explains the application code 1604 in detail and allows users to create an understanding of the generated application code 1604.

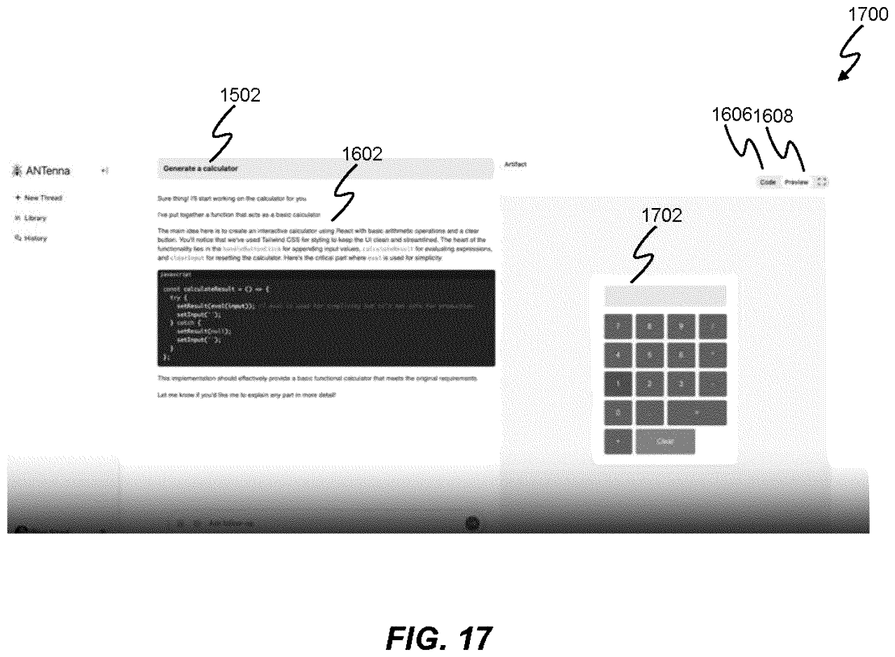

FIG. 17 depicts a user interface 1700 showing the generated calculator application 1702.

Upon clicking on the tab 1608, the user gets access to the generated application 1702, i.e., a calculator. The user can access the application 1702 and perform any function as per the user's requirements.

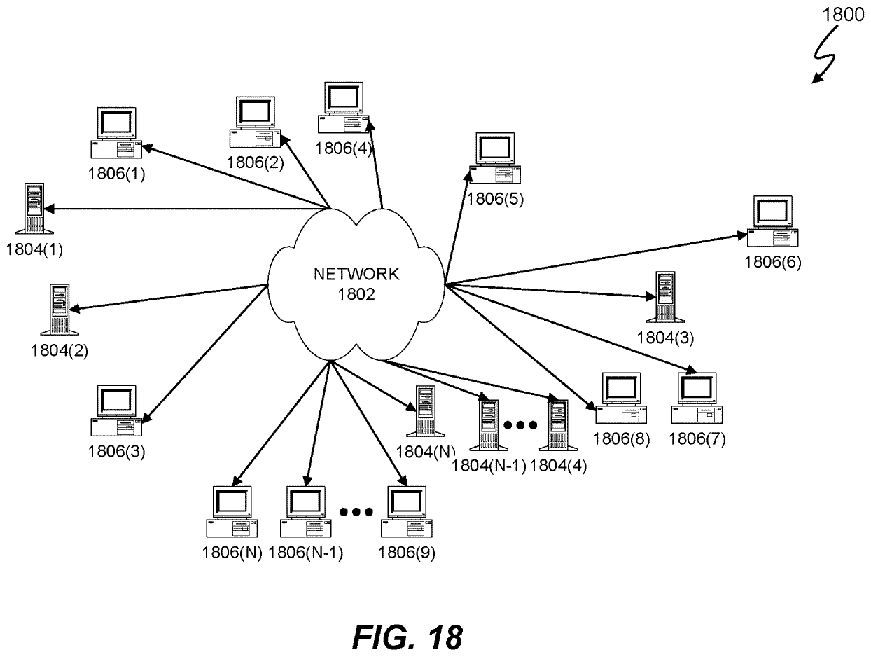

FIG. 18 is a block diagram illustrating a network environment in which an application generation system 100 and process 200 that utilizes documents ingested by the user in an online document management platform 106 may be practiced. Network 1802 (e.g. a private wide area network (WAN) or the Internet) includes several networked server computer systems 1804(1)-(N) that are accessible by client computer systems 1806(1)-(N), where N is the number of server computer systems connected to the network. Communication between client computer systems 1806(1)-(N) and server computer systems 1804(1)-(N) typically occurs over a network, such as a public switched telephone network over asynchronous digital subscriber line (ADSL) telephone lines or high-bandwidth trunks, for example, communications channels providing T1 or OC3 service. Client computer systems 1806(1)-(N) typically access server computer systems 1804(1)-(N) through a service provider, such as an internet service provider (“ISP”) by executing application-specific software, commonly referred to as a browser, on one of client computer systems 1806(1)-(N).

Client computer systems 1806(1)-(N) and/or server computer systems 18(1)-(N) are specialized computers programmed to improve conventional computer systems to implement and utilize the application generation system 100 and process 200 that utilizes documents ingested by the user in an online document management platform 106. The type of computer system that can be specially programmed to implement and utilize the application generation system 100 and process 200 that utilizes documents ingested by the user in an online document management platform 106 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the application generation system 100 and process 200 that utilizes documents ingested by the user in an online document management platform 106 can be implemented using code stored in a tangible, non-transient computer-readable medium and executed by one or more processors. In at least one embodiment, the application generation system 100 and process 200 that utilizes documents ingested by the user in an online document management platform 106 can be implemented completely in hardware using, for example, logic circuits and other circuits including field programmable gate arrays.

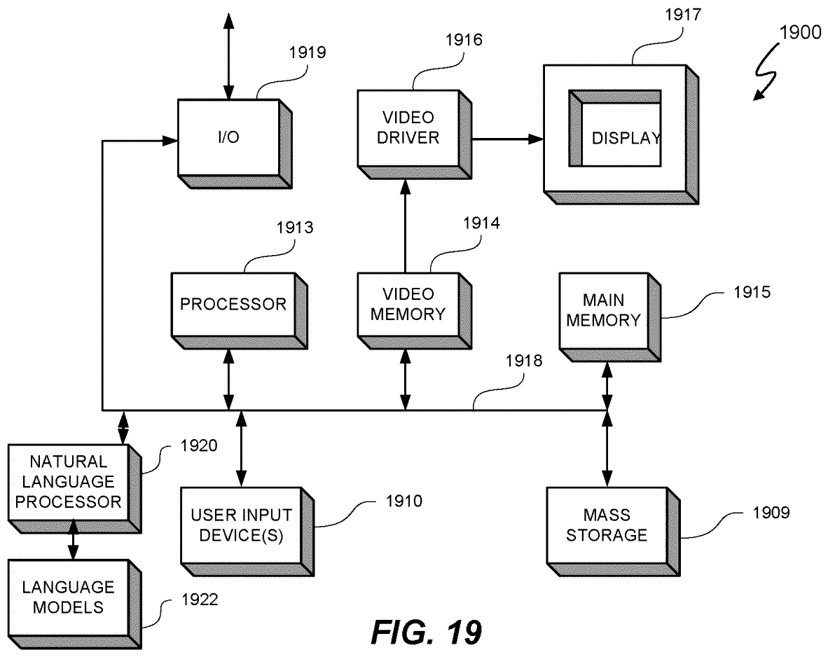

Embodiments of the application generation system 100 and process 200 that utilizes documents ingested by the user in an online document management platform 106 can be implemented on a computer system such as a special-purpose, special-programmed computer 1900 illustrated in FIG. 19. The input user device(s) 1910, such as a keyboard and/or mouse, are coupled to a bi-directional system bus 1918. The input user device(s) 1910 are for introducing user input to the computer system and communicating that user input to the processor 1913. The computer system of FIG. 19 generally also includes a non-transitory video memory 1914, non-transitory main memory 1915, and non-transitory mass storage 1909, all coupled to the bi-directional system bus 1918 along with input user device(s) 1910 and processor 1913. The mass storage 1909 may include both fixed and removable media, such as a hard drive, one or more CDs or DVDs, solid state memory including flash memory, and other available mass storage technology. Bus 1918 may contain, for example, 32 of 64 address lines for addressing video memory 1914 or main memory 1915. The system bus 1918 also includes, for example, an n-bit data bus for transferring DATA between and among the components, such as CPU 1909, main memory 1915, video memory 1914, and mass storage 1909, where “n” is, for example, 32 or 64. Alternatively, multiplex data/address lines may be used instead of separate data and address lines.

I/O device(s) 1919 may provide connections to peripheral devices, such as a printer, and may also provide a direct connection to a remote server computer system via a telephone link or to the Internet via an ISP. I/O device(s) 1919 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1909, into main memory 1915 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1915 consists of dynamic random access memory (DRAM). Video memory 1914 is a dual-ported video random access memory. One port of the video memory 1914 is coupled to the video amplifier 1916. The video amplifier 1916 is used to drive the display 1917. Video amplifiers 1916 are well-known in the art and may be implemented by any suitable means. This circuitry converts pixel DATA stored in video memory 1914 to a raster signal suitable for use by display 1917. Display 1917 is a type of monitor suitable for displaying graphic images.

The computer system described above is for purposes of example only. The application generation system 100 and process 200 that utilizes documents ingested by the user in an online document management platform 106 may be implemented in any type of computer system or programming or processing environment. It is contemplated that the application generation system 100 and process 200 that utilizes documents ingested by the user in an online document management platform 106 might be run on a stand-alone computer system, such as the one described above. The application generation system 100 and process 200 that utilizes documents ingested by the user in an online document management platform 106 might also be run from a server computer system that can be accessed by a plurality of client computer systems interconnected over an intranet network. Finally, the application generation system 100 and process 200 that utilizes documents ingested by the user in an online document management platform 106 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of generating an application by utilizing a user query, and one or more ingested documents shared by the user using an online document management platform, the method comprises:
executing code using one or more processors of a computer system to cause the computer system to perform operations comprising:
automatically ingesting one or more documents from multiple sources via., a plurality of API bundles to generate a vector database, wherein the multiple sources include local storage or cloud storage;
analyzing the vector database to identify patterns and contextual information, wherein the patterns and contextual information help in generating a priority score for the ingested documents;
receiving a natural language input from the user, wherein the natural language input includes the user query to generate an application;
generating a prompt based on the analyzed patterns and contextual information to guide an AI engine to create an application code, wherein the prompt is generated by populating a prompt structure that includes a prompt template along with rules, guidelines, and examples to generate the application;
transferring the generated prompt to the AI engine for:
generating an application code by utilizing the ingested documents, prompts, and user query; and
testing the generated application code in an automated testing environment configured to simulate real-world application usage, identify and resolve any errors; and
presenting the generated application to the user along with the application code used to create the application.

2. The method of claim 1 wherein the one or more ingested documents are available in multiple formats, including, PDF, text files, spreadsheets, emails, messages, JSON, and so on.

3. The method of claim 1 wherein the API bundles include a plurality of APIs packaged in a structured manner to collect the data from the local or cloud storage and help in ingestion.

4. The method of claim 1 wherein the analysis of the ingested documents further comprises:
utilizing NLP techniques to identify and extract key terms, and entities, including names, places, dates, and relationships within the ingested documents;
performing semantic analysis to understand the content and context of the ingested documents; and
providing a metadata tag to each analyzed document based on the content, context, and semantic analysis.

5. The method of claim 1 further comprises:
utilizing machine learning algorithms to convert the analyzed document's textual contents into vector embeddings that include numerical format;
encoding relationships between words, entities, and sections of the documents, allowing easy retrieval of information from the documents; and
chunking the embedded vector data content into smaller, coherent chunks based on semantic analysis, such as sections, paragraphs, or topics, to facilitate more granular processing and retrieval.

6. The method of claim 1 wherein the prioritization of the one or more classified documents is done based on source reliability, content importance, or freshness of the information.

7. The method of claim 1 wherein the priority score is allocated to each document during the prioritization of the one or more classified documents.

8. The method of claim 1 wherein the documents with a priority score less than 3 are ignored or not considered for application generation.

9. The method of claim 1 wherein the priority scores are utilized during information retrieval to rank documents, ensuring that higher-priority information is retrieved first in response to user queries, thereby improving the relevance of search results.

10. The method of claim 1 further comprises:
i. removing the documents with a high priority score from the list of ingested documents;
ii. re-ranking the left documents by utilizing LLM tools;
iii. combining the re-ranked documents with the documents with high priority scores.

11. The method of claim 1 wherein the AI engine is trained to handle specific programming languages and frameworks, allowing it to generate application code in languages such as Python, Java, JavaScript, React Code, Streamlit Code, or any user-specified programming language.

12. The method of claim 1 further comprises:
a feedback mechanism that updates the generated application code by iteratively analyzing the application code and user feedback to improve the prompt generation and accuracy of the AI engine based on the user feedback.

13. A system to generate an application by utilizing a user query, and one or more ingested documents shared by the user using an online document management platform comprises:
one or more processors of a computer system; and
a memory, coupled to the one or more processors, that stores code and execution of the code by the one or more processors causes the computer system to perform operations comprising:
automatically ingesting one or more documents to a data ingestor from multiple sources via., a plurality of API bundles to generate a vector database, wherein the multiple sources include local storage or cloud storage;
analyzing the vector database to identify patterns and contextual information using an analyzer, wherein the patterns and contextual information help in generating a priority score for the ingested documents;
receiving a natural language input from the user via., a chatbot, wherein the natural language input includes the user query to generate an application;
generating a prompt using a prompt generator based on the analyzed patterns and contextual information to guide an AI engine to create an application code, wherein the prompt is generated by populating a prompt structure that includes a prompt template along with rules, guidelines, and examples to generate the application;
transferring the generated prompt to the AI engine to:
generate an application code by using a code generator that utilizes the ingested documents, prompts, and user query; and
test the generated application code in an automated testing environment configured to simulate real-world application usage, identify and resolve any errors using a code tester; and
presenting the generated application to the user along with the application code used to create the application on the online document management platform.

14. The system of claim 13 wherein the plurality of API bundles are configured to support data ingestion from multiple sources, including, local storage, and cloud storage, ensuring that the ingested documents are up-to-date and available in real-time for vectorization.

15. The system of claim 13 wherein the API bundles support document ingestion in a plurality of formats, including, PDF, text files, spreadsheets, emails, messages, JSON, and so on.

16. The system of claim 13 wherein the chatbot is integrated within the online document management platform.

17. The system of claim 13 wherein the code generator may generate the application simply by using the user query and the generated prompts, without utilizing the ingested documents.

18. The system of claim 13 wherein the code tester provides detailed error logs and suggestions for improving the application code, which is automatically incorporated into the final version of the application code before presenting it to the user.

19. The system of claim 13 wherein the user is provided with an interactive user interface, integrated into the online document management platform, to review the generated application code and application, request modifications, or download the application code for further customization and deployment.

20. The system of claim 13 further comprises:
a feedback module that updates the generated application code by iteratively analyzing the application code and user feedback to improve the prompt generation and accuracy of the AI engine based on user feedback.
